(19) United States
(12) Patent Application Publication
(10) Pub. No.: US 2026/0157394 A1
(43) Pub. Date: Jun. 11, 2026

(54) EXTRUDER SYSTEM FOR FORMING A FOLDED EXTRUDATE WITH IMPROVED ORGANOLEPTIC PROPERTIES

(71) Applicants: GOOD MEAT, INC., Alameda, CA (US); BRABENDER GMBH & CO. KG, Duisburg (DE)

(72) Inventors: Siddharth BHIDE, Alameda, CA (US); Jung H. HAN, Alameda, CA (US); Peter LICARI, Alameda, CA (US); John Mampra MATHEW, Alameda, CA (US); Nathaniel Edward PARK, Alameda, CA (US); Akihiro TAKINO, Alameda, CA (US); Zachary Perry TYNDALL, Alameda, CA (US); Ryan KOWALSKI, Duisburg (DE); Christopher PIELEN, Duisburg (DE); Ivo PIASEVOLI, Duisburg (DE)

(21) Appl. No.: 19/127,266

(22) PCT Filed: Nov. 6, 2023
(86) PCT No.: PCT/US2023/078819

§ 371 Date: May 5, 2025

Related U.S. Application Data
(60) Provisional application No. 63/422,770, filed on Nov. 4, 2022.

(51) Int. Cl. A23J 3/26; A23J 3/22

(52) U.S. Cl. CPC A23J 3/26; A23J 3/227; A23V 2002/00; A23V 2300/16

(57) ABSTRACT

Apparatus, systems, and methods for forming a folded extrudate with improved organoleptic properties. The apparatus for forming the extrudate includes a body defining a flow path extending from an inlet at an upstream end of the body to an outlet at a downstream end of the body. The inlet has a first cross-sectional area, and the outlet has a second cross-sectional area that is larger than the first cross-sectional area. Additionally, the flow path includes a transitional region at the upstream end of the body with a length L and a minimum cross-sectional expansion ratio of at least 2× for any continuous length L/2 over the length L of the transitional region, and the flow path includes a forming region extending from the transitional region to the outlet.

### CROSS-REFERENCE TO RELATED APPLICATIONS

The present application is a National Stage Phase entry of PCT Application No. PCT/US2023/078819, filed Nov. 6, 2023, which, in turn, claims the benefit of and priority to U.S. Ser. No. 63/422,770, filed Nov. 4, 2022, which is incorporated by reference herein in its entirety.

### TECHNICAL FIELD

Extruder systems for the manufacture of food products, such as cultivated meat products, and methods of making and using thereof are disclosed herein.

### BACKGROUND

Cultivated or cultured meat has the potential to overcome the adverse environmental impacts and animal welfare concerns associated with farm-raised meat. However, to do so, cultivated, or cultured, meat should mimic the taste and texture of farm-raised meat. Existing systems and methods for forming cultivated meat products have not been successful at replicating the organoleptic properties of farm-raised meat, such as mouthfeel, texture, and moisture content. The mouthfeel of farm-raised meat can be attributed, at least in part, to the fibrous structure of the meat, which have not been adequately replicated by conventional systems and processing methods that rely exclusively on molding to impart structure.

Extruders are machines that can be used to manufacture a variety of goods ranging from plastics and rubbers to food products. Generally, the extrusion process involves introducing one or more feed materials into the barrel of the extruder. One or more rotating screws housed co-axially within the barrel mixes and melts the feed materials as it conveys the feed materials along a length of the barrel. The melted feed materials are then forced through a die that shapes the extruded product, i.e., the extrudate.

In the extruder barrel, the feed materials are typically subjected to high temperature and high pressure. When expelled from a die at the end of the extruder barrel, the expansion of the extrudate coupled with the rapid reduction in pressure causes the moisture in the extrudate to flash, forming an extrudate with a low moisture content. Thus, with respect to food products, extruders have typically been used to create low-moisture food products, such as dried pastas, breakfast cereals, pet food, and ready-to-eat, salty snacks. These conventional extruder systems and processes make extrusion impractical for forming high-moisture food products, such as plant-based meat products; cultivated meat products; and hybrid products containing plant-based materials and animal cells. These meat products have grown in popularity amongst consumers desiring to reduce meat consumption and/or lessen the environmental impact associated with industrial animal farming.

### SUMMARY

There exists a need for apparatus, systems, and methods for creating cultivated, or cultured, meat products with organoleptic properties associated with farm-raised meat.

There is also a need for extrusion apparatus, systems, and methods to produce cultivated, or cultured meat, products that require higher moisture contents than the types of food products typically manufactured via extrusion.

An apparatus for forming an extrudate, and methods of making and using thereof, are described herein. In some embodiments, the apparatus is adapted to extrude a composition containing an animal cell paste. In some embodiments, the composition to be extruded contains a mixture of animal cell paste and plant protein (sometimes referred to as “hybrid” products). In some embodiments, the composition contains one or more additional components or ingredient to be extruded with the animal cell paste or animal cell paste+plant protein. Non-limiting examples of the cultivated or cultured meat products include chicken, turkey, duck, beef, pork, lamb, anchovies, bass, catfish, cod, flounder, grouper, haddock, hake, halibut, herring, mahi mahi, perch, pike, pollock, salmon, scrod, sole, snapper, swordfish, tilapia, trout, tuna, shrimp, prawns, crab and lobster, clams, mussels, oysters, scallops, octopus, squid, abalone, snail, and jellyfish.

In some embodiments, the apparatus includes a cooling die that has a body defining a flow path extending from an inlet at an upstream end of the body to an outlet at a downstream end of the body. In some embodiments, the inlet has a first cross-sectional area, and the outlet has a second cross-sectional area that is larger than the first cross-sectional area. In some embodiments, the flow path can include a transitional region at the upstream end of the body with a length L and a minimum cross-sectional expansion ratio of at least 2× for any continuous length L/2 over the length L of the transitional region, and the flow path includes a forming region extending from the transitional region to the outlet.

Formulation for forming an extrudate with a texture like a farm-raised animal counterpart are also described herein. In some embodiments, the formulation includes cultivated or cultured animal cells in an amount between about 3% to about 95 wt % of the formulation, and a dry mix in an amount between 25-45 wt % of the formulation. In some embodiments, the dry mix includes at least a proteinaceous ingredient, a binding ingredient, an emulsifier, and one or more flavorants.

In some embodiments, the extrudate is formed from a mixture of cultivated animal cells and a proteinaceous ingredient. In some embodiments, the extrudate includes an elongated body with a generally elliptical (e.g., regular ellipse), elliptical-like (e.g., irregular ellipse) or tear-drop shaped cross-section. In some embodiments, the elongated body includes irregular folds at a surface of the elongated body and disposed throughout a volume of the elongated body, and the extrudate has a texture that is the same or similar to a farm-raised animal counterpart.

Methods for forming an extrudate from a formulation including cultivated animal cells and a proteinaceous ingredient are also described herein. In some embodiments, the method includes a step of receiving an intermediate extrudate into a flow path of a cooling die. In an exemplary embodiment, the flow path extends from an inlet with a first cross-sectional area at an upstream end of the cooling die to an outlet with a second cross-sectional area at a downstream end of the cooling die. In some embodiments, the flow path additionally includes a transition region at the upstream end and a forming region at the downstream end. In some embodiments, the flow path is dimensioned so that the intermediate extrudate is received at the inlet at a first mass flux and crosses an interface between the transition region and the forming region at a second mass flux that is at least 4× less than the first mass flux. In some embodiments, the method also includes cooling the intermediate extrudate at a cooling rate that provides a first temperature reduction per unit length of at least 4° C./cm and expelling the intermediate extrudate from the cooling die to form the extrudate.

Systems for forming an extrudate are also described. In some embodiments, the system includes an extruder barrel housing a set of screws and a set of feed streams coupled to one or more inlets of the extruder barrel. The set of feed streams provide feed material processed within the extruder barrel. In some embodiments, the system also includes a cooling die fluidically coupled to an outlet of the extruder barrel, the cooling die having a body defining a flow path extending from an inlet at an upstream end of the body to an outlet at a downstream end of the body. In some embodiments, the inlet additionally has a first cross-sectional area, the outlet has a second cross-sectional area that is larger than the first cross-sectional area, the flow path includes a transitional region at the upstream end of the body with a length L and a minimum cross-sectional expansion ratio of at least 2× for any continuous length L/2 over the length L of the transitional region, and the flow path includes a forming region extending from the transitional region to the outlet.

An apparatus for forming an extrudate are also described herein. In some embodiments, the apparatus includes a body defining a flow path extending from an inlet at an upstream end of the body to an outlet at a downstream end of the body. In some embodiments, the inlet has a first cross-sectional area with a first geometric shape, the outlet has a second cross-sectional area with a second geometric shape, and the second cross-sectional area is larger than the first cross-sectional area and the second geometric shape is elliptical (e.g., regular ellipse), elliptical-like (e.g., irregular ellipse) or tear-drop.

Although embodiments of this disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. Recitation of ranges of values herein are merely intended to serve as a shorthand method of referring individually to each separate value falling within the range, unless otherwise indicated herein, and each separate value is incorporated into the specification as if it were individually recited herein.

Disclosed are materials, compositions, systems, apparatuses, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a ligand is disclosed and discussed and a number of modifications that can be made to a number of molecules including the ligand are discussed, each and every combination and permutation of ligand and the modifications that are possible are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. Further, each of the materials, compositions, components, etc. contemplated and disclosed as above can also be specifically and independently included or excluded from any group, subgroup, list, set, etc. of such materials.

These concepts apply to all aspects of this application including, but not limited to, steps in methods of making and using the disclosed compositions as wells and the systems and apparatuses and their respective uses. Thus, if there are a variety of additional steps that can be performed it is understood that each of these additional steps can be performed with any specific embodiment or combination of embodiments of the disclosed methods, and that each such combination is specifically contemplated and should be considered disclosed.

All methods described herein can be performed in any suitable order unless otherwise indicated or otherwise clearly contradicted by context. The use of any and all examples, or exemplary language (e.g., “such as”) provided herein, is intended merely to better illuminate the embodiments and does not pose a limitation on the scope of the embodiments unless otherwise claimed. No language in the specification should be construed as indicating any non-claimed element as essential to the practice of any embodiment.

Additionally, where an embodiment is described herein as comprising or including some element or group of elements, additional embodiments can consist essentially of or consist of the element or group of elements. Also, although the open-ended terms “comprises” and “includes” is generally used herein, additional embodiments can be formed by substituting the terms “consisting essentially of” or “consisting of.”

Other aspects, embodiments and features of the disclosure will become apparent from the following detailed description of the disclosure when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the disclosure shown where illustration is not necessary to allow those of ordinary skill in the art to understand the disclosure and accompanying non-limiting embodiments.

### BRIEF DESCRIPTION OF THE DRAWINGS

Characteristic of the disclosure are set forth in the appended claims. The disclosure and accompanying embodiments, however, as well as a preferred mode of use, further objectives, and advantages thereof, will be best understood by reference to the following detailed description of illustrative embodiments when read in conjunction with the accompanying figures, wherein:

FIG. 1 is an elevation view of an extruder in accordance with an illustrative embodiment.

FIG. 2 is a perspective view of an extruder barrel and connecting die for forming an extrudate in accordance with an illustrative embodiment.

FIGS. 3A and 3B are various views of a cooling die for forming an extrudate in accordance with an illustrative embodiment.

FIGS. 4A and 4B are various views of the cooling fluid flow path through cooling die modules of the cooling die in accordance with an illustrative embodiment.

FIGS. 5A-5E are various views of a base module of the cooling die according to an illustrative embodiment.

FIG. 6A-6E are various views of a body module of the cooling die according to an illustrative embodiment.

FIG. 7 is a plan view of a cooling die depicting an intermediate extrudate conveyed through a flow path at a first mass flow rate accordance with an illustrative embodiment.

FIG. 8 is a plan view of a cooling die depicting an intermediate extrudate conveyed through a flow path at a second mass flow rate accordance with an illustrative embodiment.

FIG. 9 is a multivariable graph depicting various parameters as function of distance for a system configured according to an illustrative embodiment.

FIG. 10 is a graph depicting mass flux of intermediate extrudate through the flow path of the cooling die in accordance with an illustrative embodiment.

FIG. 11 is a graph depicting a cooling rate versus mass flux through a flow path of the cooling die in accordance with an illustrative embodiment.

FIG. 12 is a graph depicting temperature and cooling rate as a function of position in accordance with an illustrative embodiment.

FIG. 13 is a graph depicting temperature gradient of an intermediate extrudate as a function of position in accordance with an illustrative embodiment.

FIG. 14 is a graph depicting temperature gradient of an intermediate extrudate as a function of position for varying throughput in accordance with an illustrative embodiment.

FIG. 15 is a flowchart of a process for forming an extruded product from a dry mix.

FIG. 16 is a flowchart of a process for forming an extruded product from a dry mix and cell paste in accordance with an illustrative embodiment.

FIG. 17 is a flowchart of a process for forming an extruded product from cell paste in accordance with an illustrative embodiment.

FIG. 18 is a picture of an extrudate formed in accordance with an illustrative system and method.

FIG. 19 is a picture of extrudate formed in accordance with an illustrative system and method and cooked to form a food product similar to a farm-raised animal counterpart.

FIG. 20 is a graph depicting the calculation of various texture characteristics of an extrudate formed in accordance with an illustrative embodiment.

### DETAILED DESCRIPTION

### I. Definitions

As used herein, the term “proteinaceous ingredient” means an ingredient that has at least 60% protein by dry weight. Other non-limiting examples of these proteinaceous ingredients can include pulse/legume, grain, seed, nut, starch, flour, insect, fungi, animal or animal cell, plant cell, or microorganism. The proteinaceous ingredients can be obtained by any process, including extraction, filtration, microbial fermentation, biomass fermentation, or cellular culture, to name a few.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied.

All methods described herein can be performed in any suitable order unless otherwise indicated or otherwise clearly contradicted by context. The use of any and all examples, or exemplary language (e.g., “such as”) provided herein, is intended merely to better illuminate the embodiments and does not pose a limitation on the scope of the embodiments unless otherwise claimed. No language in the specification should be construed as indicating any non-claimed element as essential to the practice of embodiments of the disclosure.

### II. Extruder

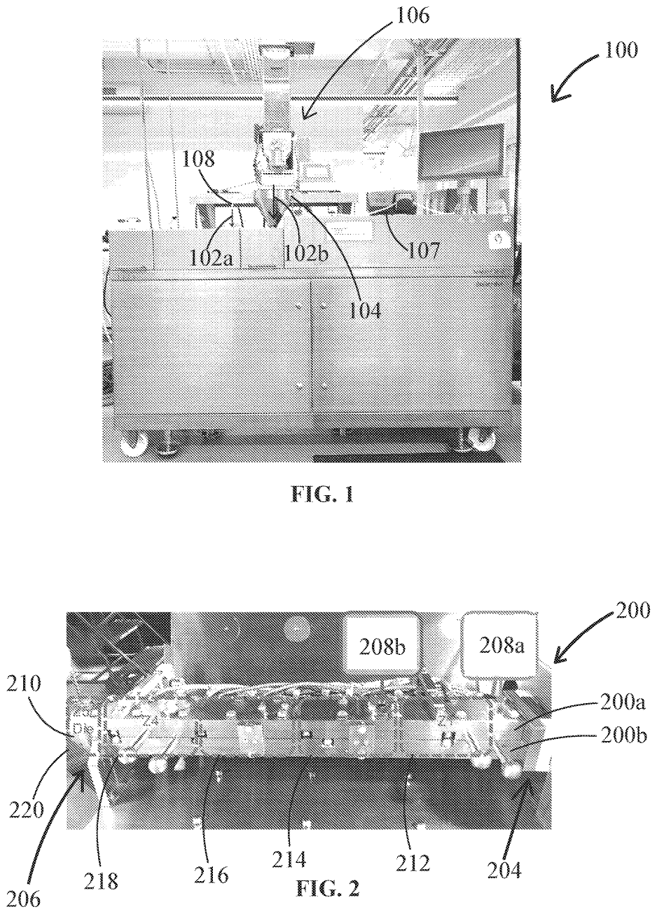

FIG. 1 is an elevation view extruder in accordance with an illustrative embodiment. The extruder 100 can be any one of a number of conventional extruders uniquely configured to create a dough that can be fed through a cooling die to create a extrudate as described in this disclosure. Non-limiting examples of the extruder 100 can include a single-screw wet extruder, a single-screw dry extruder, a single-screw interrupted-flight extruder, and a twin-screw extruder. The twin-screw extruder can be used in wet extrusion methods or dry extrusion methods. For the sake of simplicity and consistency, the extruder 100 is a twin-screw extruder that includes an extruder barrel 200, shown in more detail in FIG. 2.

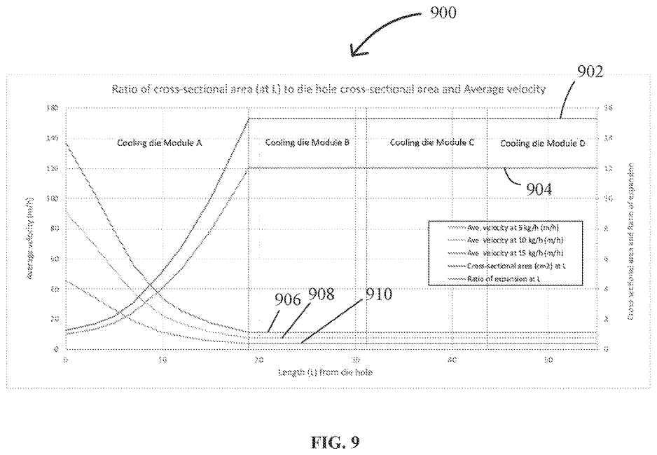

The extruder 100 creates an intermediate extrudate, such as extrudate 700 and extrudate 900 shown in more detail in FIGS. 8 and 9, respectively, by extrusion cooking. Extrusion cooking is a thermo-mechanical process providing continuous mixing, kneading, and shaping of a dough that can include a variety of ingredients, including a cultivated animal cells (and a plant-based protein).

Cultivated animal cells are a source of animal protein cultivated in vitro in a suitable growth media. In some embodiments, the media contains animal serum and/or animal-derived components. In some embodiments, the media does not contain animal serum and/or animal-derived components. Cultivated animal cells can be formed by a process described in U.S. Patent Application Publication No. 2022/0079197, which is hereby incorporated in its entirety.

Exemplary forms of cultivated animal cells include bovine cells, avian cells, porcine cells, and fish cells. The cultivated animal cells are a preferred source of animal-based protein that provides better organoleptic properties in an extrudate than other forms of animal-based protein, such as chopped, blended, or pulverized animal protein.

In a non-limiting embodiment, the extruder 100 can create the dough from a set of feed streams 102. As used herein, the term “set” means one or more. Thus, a set of feed streams can be a single stream or two or more streams. In this illustrative embodiment, the set of feed streams includes two feed streams represented by arrows 102a and 102b, which are referred to collectively as the set of feed streams 102. The set of feed streams 102 provides the ingredients to form the dough. In this illustrative embodiment in FIG. 1, the set of feed streams 102 includes a first feed stream 102a that is formed entirely, or at almost entirely, from dry mix ingredients and a second feed stream 102b that is formed entirely, or almost entirely, from wet ingredients. In some embodiments, the wet ingredients can include a liquid, such as water, or a cell paste formed from cultivated animal cells.

In some embodiments, the first feed stream 102a is fed into the extruder 100 through a hopper 104 that can receive the dry mix through a feeder 106. The feeder 106 can be a volumetric feeder or gravimetric feeder. The second feed stream 102b is fed into the extruder by a pump 107 through a feed conduit 108 fluidically coupled to reservoir storing the second feed stream (not shown). The pump can be any form of pump, such as a peristaltic pump. The set of feed streams 102 can be fed into the barrel 200 of the extruder 100 and is conveyed down the length of the barrel 200 by mechanical pressure exerted on the dough by the set of screws and the barrel 200. In some embodiments, the dough can be cooked in the barrel 200 from the heat produced by the friction and increased pressure created by the dough passing through the barrel. In some embodiment, the barrel 200 can be heated with an external heating device or cooled with an external cooling device, to provide the desired cooking temperature profile. As the dough is conveyed along the barrel 200, one or more ports disposed throughout the extrudate barrel 200 can be used to inject other ingredients, including oil, water, sugar solutions and/or flavorants.

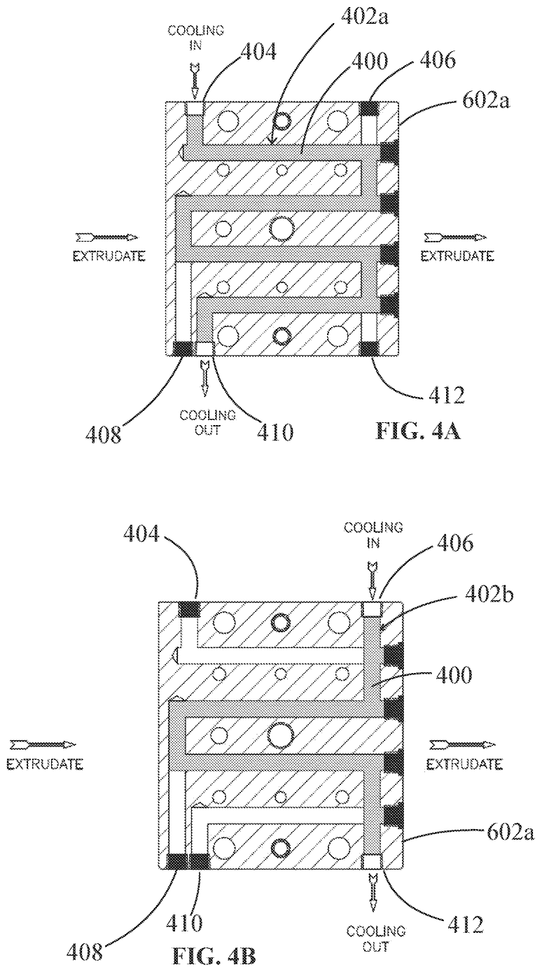

In some embodiments, as the dough is conveyed to the end of the barrel 200, the dough is expelled from the extruder 100 through a connecting die 210 to form an intermediate extrudate that is further processed in a cooling die 300 to form a folded extrudate expelled from an end of the cooling die 300. An example of the intermediate extrudate is shown in FIGS. 8 and 9, as well as the flow path 702, and an example of the cooling die is shown and described in more detail in FIG. 4.

In some embodiments the extrudate can be formed using a wet extrusion process or a dry extrusion process. While not being bound by theory, it is believed that a wet extrusion process produces extrudates with a more pronounced fibrous structure. It is believed that as the dough travels through the barrel, the protein molecules and/or the protein molecules covalently linked to cultivated animal cells undergo laminar flow and are realigned into fibrous strands, leading to a product that is similar to the texture of meat obtained from a farmed animal.

In some embodiments, in a “wet extrusion” process, the moisture content of the dough is above about 40% by weight, i.e., 40 wt %. In some embodiments, the moisture content of the dough in a wet extrusion process is 40-45 wt %, 45-50 wt %, 50-55 wt %, 55-60 wt %, 60-65 wt %, 65-70 wt %, 75-80 wt %, 80-85 wt %, 85-90 wt %, or 90-95 wt %. In some embodiments, in a “dry extrusion” process, the moisture content of the dough is below about 40 wt %. In some embodiments, the moisture content of the dough in the dry extrusion process is 5-10 wt %, 10-15 wt %, 15-20 wt %, 20-25 wt %, 25-30 wt %, or 35-40 wt %.

In some embodiments, the dry ingredients are placed in the hopper, the dry ingredients containing or including one or more plant proteins. In some embodiment, the dry ingredients contain or include one or more plant proteins, at least one other ingredient and/or dry peptide-cross linking agent to prepare a dry ingredient mixture. In other embodiments, the dry ingredients contain or include plant protein and dried cultivated animal cells. The cultivated animal cells can be dried using conventional drying methods including freeze-drying or dried by applying heat and/or vacuum to the cultivated animal cells. The dry ingredient mixture is placed into the barrel of an extrusion at a desired loading rate. As the dry ingredient mixture is conveyed through the barrel, a dough is prepared by injecting steam or water into the barrel. The dough is conveyed through the barrel and is optionally heated. In some embodiments where the cultivated animal cells is not a dry ingredient, the cultivated animal cells is injected into the barrel to prepare the dough. In other embodiments. The dough is extruded through a die to prepare the intermediate extrudate.

Processes for making a food product are also described. In some embodiments, the process includes combining pulse protein, cell paste and a phosphate into water and heating the mixture in three steps. In certain embodiments, the processes including adding phosphate to water to prepare conditioned water. In certain embodiments, a pulse protein is added to the conditioned water to hydrate the pulse protein to prepare hydrated plant protein. In some embodiments, cell paste is added to the hydrated plant protein (conditioned water to which a plant protein has been added) to produce a cell protein mixture.

In some embodiments, the plant protein is a pulse protein. In some embodiments, the pulse protein is a mung bean protein.

In some embodiments, the phosphate is selected from the group consisting of disodium phosphate (DSP), sodium hexametaphosphate (SHMP), tetrasodium pyrophosphate (TSPP). In some embodiments, the phosphate added to the water is DSP. In some embodiments, the amount of DSP added to the water is at least or about 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.11 wt %, 0.12 wt %, 0.13 wt %, 0.14 wt %, 0.15 wt %, or greater than 0.15 wt %.

In some embodiments, the processes include preparing a cultivated meat product by placement into cooking molds. In some embodiments, the processes include applying a vacuum to the cooking molds effectively changing the density and texture of the cultivated meat product.

In some embodiments, the extrudate has a hardness as measured by a puncture test of between 1-50 N, between 1-45 N, between 1-40 N, between 1-35 N, between 1-30 N, between 1-25 N, between 1-20 N, between 1-15 N, between 1-10 N, between 1-9 N, between 1-8 N, between 1-7 N, between 1-6 N, between 1-5 N, between 1-4 N, between 1-3 N, between 1-2 N, between 2-15 N, between 2-10 N, between 2-9 N, between 2-8N, between 2-7 N, between 2-6 N, between 2-5 N, between 2-4 N, or between 2-3 N.

FIG. 2 is a perspective view of an extruder barrel and connecting die for forming an extrudate in accordance with an illustrative embodiment. The extruder barrel 200 is an elongated body that defines a bore extending through the elongated body from an upstream end 204 to a downstream end 206. Housed within the bore is a set of screws (not shown) that can be exposed by separating the upper housing 200a from the lower housing 200b. The set of screws can be co-extensively aligned within the bore. The set of screws are powered by a motor (not shown) housed within the extruder 100.

The set of screws can be configured with various dimensions, e.g., diameter, pitch, flight width, flight clearance, helix angle, channel depth, etc., so that the extruder barrel 200 can define one or more differing processing zones within the extruder barrel. Examples of the differing processing zones cab include the feeding zone, the melting zone, and the metering zone.

The various dimensions of the set of screws can be based on the size of the extrusion unit. The radius of the screw can be as small as 8 mm for bench extrusion machines, or as large as 100 mm or larger for commercial production machines. The pitch of the screws can be of various sizes and angles. The pitch of the various portions of the screw usually has an angle of between 30-90°. The pitch angle (helix angle) of the screw can be 30-35°, 35-40°, 40-45°, 45-50°, 50-55°, 55-60°, 60-65°, 65-70°, 70-75°, 75-80°, 80-85°, or 85-90°. Typically, the greater the angle, the stronger the shear force. The rotational frequency of the screw relative to the diameter of the screw is a common design parameter of the screw. For a screw that is 0.5 D pitch, the screw completes one full rotation (360°) in 0.5 diameters. Common screws 0.25 D, 0.5 D, 0.75 D, and 1.0 D, and screws with other pitch parameters are commercially available and can be customized by suppliers.

The set of screws can be a single screw or a pair of screws, commonly referred to as twin screws. In a single screw extruder, the screw design could have various configurations including decreasing pitch, increasing core, threaded barrel, conical barrel or alternating pin-type screw, or other screw design. In a twin-screw extruder, there are two screws. The two screws can be arranged to rotate in a concurrent manner or in a countercurrent manner. In concurrent twin-screw designs, the two screws rotate in the same direction, that is, both screws rotate clockwise or counterclockwise. In countercurrent twin-screw designs, the two screws counterrotate, that is, the one (first) screw rotates clockwise, and the other (second) screw rotates counterclockwise. In both concurrent and countercurrent designs, the two screws can intermesh or not intermesh (tangential). In non-intermeshing designs, the interaxial distance of the two screws are designed such that the flight path of one screw does not infiltrate the flight path of the second screw. In intermeshing twin-screw designs, the interaxial distance of the screws are designed so that the flight path of one screw infiltrates the flight path of the second screw. Depending on the depth of the infiltration, the screw configuration can be described as self-cleaning or partially self-cleaning. In addition, the handedness of the screw can be varied. One or both screws of the extruder can be right-handed or left-handed as viewed from a particular perspective, either downstream or upstream.

Modern extrusion machines often use modular screw designs that allows use of different screws having different configurations to quickly implement process changes. The screw configuration is designed in a way to optimize the drag speed, pressure speed and other parameters to achieve optimal mixing, shearing and/or heat transfer to obtain the desired laminated internal texture of cultivated cell extrudates. The screw assembly in one embodiment, can be the following: (1) fully intermeshing counter-rotating twin screw design; (2) fully intermeshing co-rotating twin screw design; (3) non-intermeshing (tangential) counter-rotating twin screw design; and (4) non-intermeshing (tangential) co-rotating twin screw design. Splined shafts are usually employed to hold screw sections of varying configuration: forward pitch, reverse screw, forward paddle and reverse paddle, kneading disks, compression disks.

At the upstream end 204 of the extruder barrel 200 is a set of feed ports 208. In the non-limiting embodiment depicted in FIG. 2 the set of feed ports 208 includes a dry feed port 208a located upstream from the wet feed port 208b. At the downstream end 206 of the extruder barrel 200 is a connecting die 210. The connecting die 210 couples the extruder barrel 200 with the cooling die 300.

The extruder barrel 200 and connecting die 210 can be divided into a plurality of different temperature zones to create a cooking temperature profile for cooking a dough conveyed through the extruder barrel 200. In this illustrative embodiment, the extruder barrel 200 is divided into five temperature zones, Zone 1 212, Zone 2 214, Zone 3 216, Zone 4 218, and Zone 5 220. Each of the temperature zones can be maintained at a predetermined temperature by conventional heating or cooling devices to create an optimal temperature profile for cooking the dough. In a non-limiting example, a generally inverted parabolic temperature profile has shown to be optimal for creating a dough from plant-based proteins and cultivated animal cells. In a more specific example, the temperature profile has a higher temperature in Zone 2 214-Zone 4 218 as compared to the temperature in temperature Zone 1 212 and Zone 5 220. A particular exemplary temperature profile that can be used in part or in whole is presented in Table 12 in the Examples Section.

The pressure in the barrel can differ in the different zones. The pressures in the different zones can be as low as 1 bar up to 300 bar and beyond. For dry extrusion, the pressures inside the barrel are typically higher than in wet extrusion. The pressures in the barrels of the extrusion machines used to prepare extrudates described herein can be between 1-10 bar, 10-20 bar, 20-30 bar, 30-40 bar, 40-50 bar, 50-60 bar, 60-70 bar, 70-80 bar, 80-90 bar, 90-100 bar, 100-110 bar, 110-120 bar, 120-130 bar, 130-140 bar, 140-150 bar, 150-160 bar, 160-170 bar, 170-180 bar, 190-200 bar, 200-210 bar, 210-220 bar, 220-230 bar, 230-240 bar, 240-250 bar, 250-260 bar, 260-270 bar, 270-280 bar, 280-290 bar, or 290-300 bar.

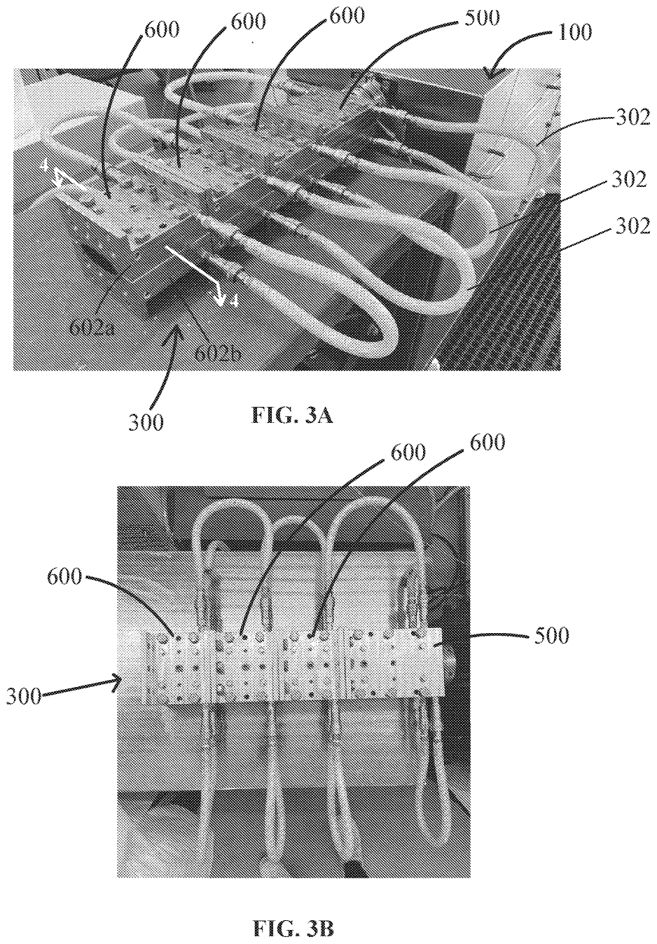

FIGS. 3A and 3B are various views of a cooling die for forming an extrudate in accordance with an illustrative embodiment. FIG. 3A is a perspective view of the cooling die 300 and FIG. 3B is a plan view of the cooling die 300. The cooling die 300 exposes an intermediate extrudate to process conditions and a particularly dimensioned flow path to impart the desired organoleptic properties to the extrudate product expelled from the cooling die 300.

In a non-limiting embodiment, the cooling die 300 is formed from a plurality of cooling die modules. The plurality of cooling die modules can include a base module 500 and set of body modules 600. In particular, the exemplary cooling die 300 includes one base module 500 and three body modules 600.

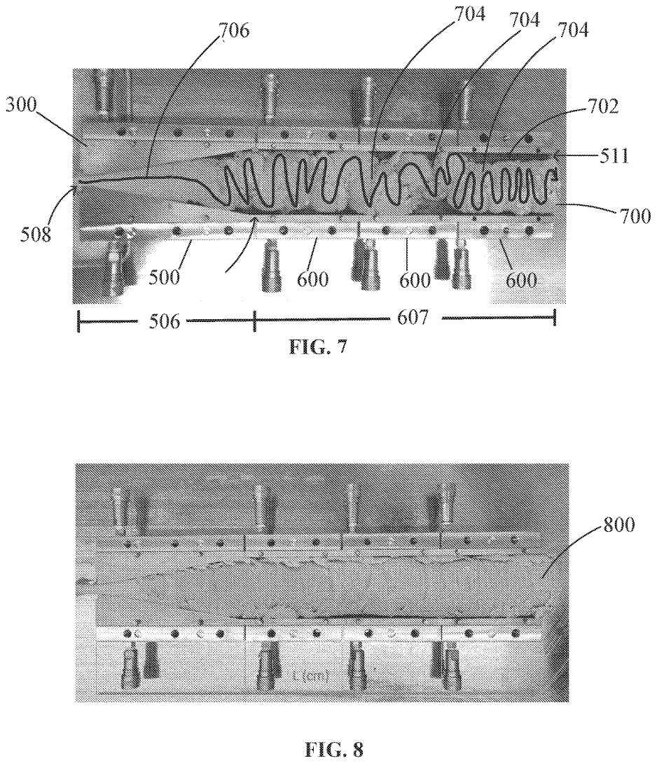

Each of the cooling die modules houses a respective cooling die that defines a portion of the flow path 702 that extends through the cooling die 300. The flow path 702 is shown and described in more detail in FIG. 7 that follows. The base module 500 houses a transition die that defines a transition region 506 of the flow path 702. In a non-limiting embodiment, the transition region 506 of the flow path 702 can be described as a generally flattened frustoconical shape with a circular cross-section at the inlet which transitions into an elliptical (e.g., regular ellipse), elliptical-like (e.g., irregular ellipse) or tear-drop shaped cross-section at an end of the transition region 506.

The shape of the transition region 506 is selected to provide the requisite cross-sectional expansion ratio and cooling rate in the upstream end of the flow path, and to cause the intermediate extrudate to begin its generally serpentine flow through the remainder of the flow path 702, which imparts the folded structure to the intermediate extrudate. As such, the remainder portion of the flow path 702 downstream from the transition region 506 may be referred to as the forming region 607. The number of body modules 600 can be selected based on a desired length of the forming region 607. While the forming region 607 is shown by the concatenation of three body modules 600, in another embodiment the forming region 607 can be housed within a single elongated die having the desired length. At least one benefit of the modular design provided by the body modules 600 is the ability to easily customize the length of the forming region 607 to create extrudates with varying organoleptic properties.

In the illustrative embodiment in FIG. 3, the terminal end of the flow path 702 is an outlet with an elliptical (e.g., regular ellipse), elliptical-like (e.g., irregular ellipse) or tear-drop shaped cross-section. However, in another embodiment, the outlet can have a different shape, such as a rectangular, square, circular, triangular, trapezoidal, or other shape. Further, the outlet can have a cross-sectional area that is larger than the cross-sectional area of the inlet, smaller than the cross-sectional shape of the inlet, or the same size.

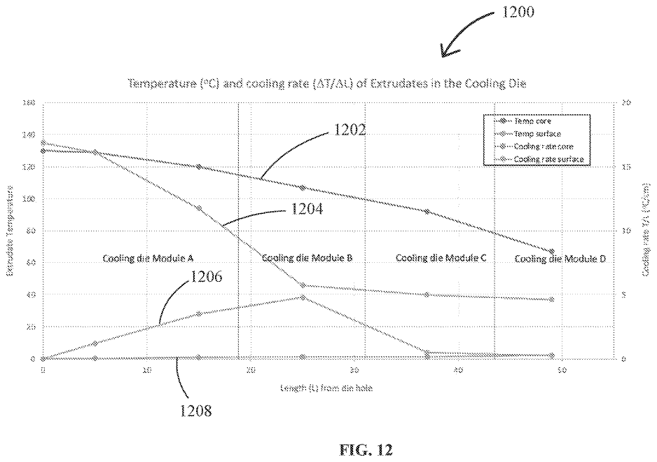

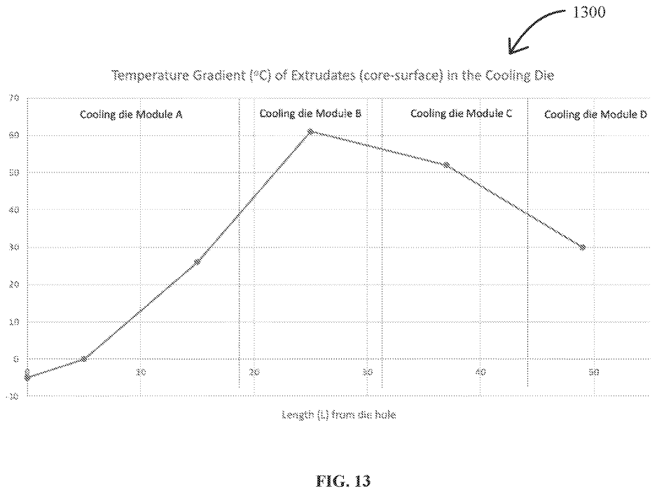

The cooling die 300 cools the intermediate extrudate according to a desired cooling rate as shown and described in FIGS. 11 and 12. In this illustrative embodiment in FIGS. 3A and 3B, the cooling die 300 provides the desired cooling rate by a water-cooling system that provides cooling water at a predetermined temperature setpoint through the water lines 302 as described in more detail in FIG. 4 that follows. Exemplary temperature setpoints are provided in Table 12.

FIGS. 4A and 4B are various views of the cooling fluid flow path through cooling die modules of the cooling die in accordance with an illustrative embodiment. FIGS. 4A and 4B are cross-sectional views of the body module 600 in FIG. 3A, taken along line 4-4.

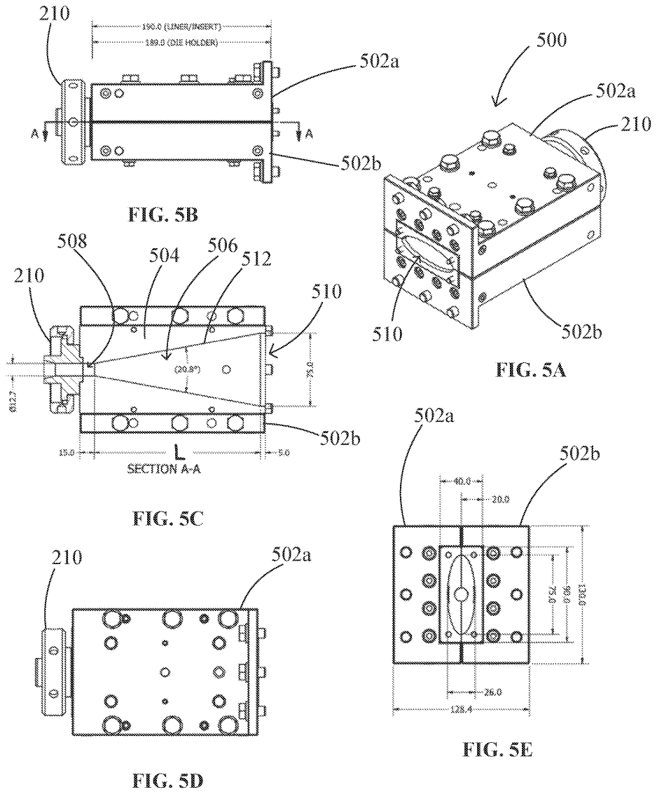

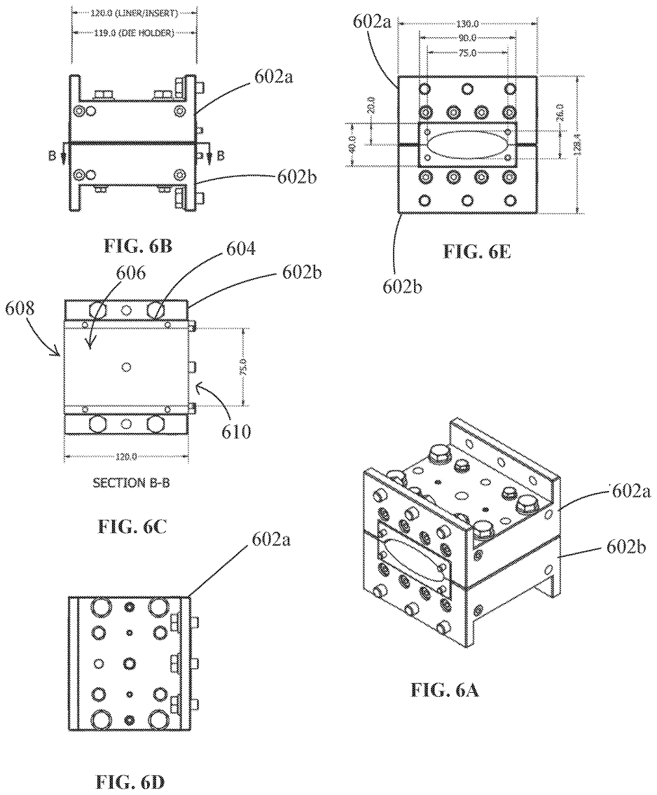

With reference to FIG. 4 and FIG. 6, the body module 600 is formed from an upper enclosure 602a that can be releasably secured to the lower enclosure 602b. Each of the enclosures 602a and 602b can house a network of channels connected to openings that can be selectively plugged to redirect cooling fluid 400 through one of two cooling fluid flow paths, i.e., cooling fluid flow path 402a, depicted in FIG. 4A or cooling fluid flow path 402b, depicted in FIG. 5B. The cooling fluid flow path 402a provides even distribution of cooling fluid 400 throughout the cooling die module 600. The cooling fluid flow path 402b concentrates the distribution of cooling fluid 400 in the center region of the cooling die module 600.

The cooling fluid 400 can be directed through cooling fluid flow path 402a by plugging openings 406, 408, and 412. Feeding the cooling fluid into opening 404 causes the cooling fluid to flow through cooling fluid flow path 402a and out of opening 410. The cooling fluid 400 can be directed through cooling fluid flow path 402b by plugging opening 404, 408, and 410. Feeding the cooling fluid into opening 406 causes the cooling fluid to flow through cooling fluid flow path 402b and out of opening 412. Each cooling die module can include the network of channels that form the cooling fluid flow paths 402a and 402b in each half of the enclosure.

In some embodiments, water can be used as the cooling fluid 400. The cooling fluid can be cooled by any of a number of conventional cooling units that can chill the cooling fluid before pumping the cooling fluid into the network of cooling fluid channels in each of the enclosures, e.g., enclosure 502a, 502b, 602a, and 602b for a two-module cooling die. The spent cooling fluid can be returned to the chiller before being recirculated back to the network of cooling fluid channels in each of the enclosures. Thus, each of the enclosures 502a, 502b, 602a, and 602b has its own cooling fluid circuit. In another embodiment, the network of cooling fluid flow paths in each cooling die enclosure 502a, 502b, 602a, and 602b are fluidically connected to each other so that a single cooling fluid circuit is formed. In this embodiment, cooling die enclosure 502a is fluidically connected to enclosure 502b, which is fluidically connected to enclosure 602a, which is connected to enclosure 602b. A cooling unit can send chilled cooling fluid through a feed line into the enclosure 502a which then flows into enclosures 502b, 602a, and 602b in turn before the spent cooling fluid is returned to the cooling unit.

The exemplary cooling die 300 described herein relies on a cooling fluid that is formed entirely or at least primarily from water. However, in another embodiment, other types of cooling fluid can be used instead. In yet another embodiment, other forms of cooling systems can be implemented which provide the requisite cooling rate for the intermediate extrudate to acquire the desired temperature gradient and folded structure.

FIGS. 5A-5E are various views of a base module of the cooling die according to an illustrative embodiment. FIG. 5A is a perspective view of the base module 500, FIG. 5B is a side elevation view of the base module 500, FIG. 5C is a view of the base module 500 taken along line A-A in FIG. 5B, FIG. 5D is a plan view of the base module 500, and FIG. 5E is an elevation view of an end of the base module 500.

The base module 500 is formed from an enclosure 502 that houses a transition die 504. In this illustrative embodiment, the enclosure 502 includes an upper enclosure 502a and a lower enclosure 502b. The enclosure 502 can be secured together using conventional fasteners. In this illustrative embodiment, the upper enclosure 502a and lower enclosure 502b are bolted together. Separability of the enclosure 502 facilitates repair, replacement, and/or cleaning of the transition die 504.

The transition die 504 defines an interior cavity that forms the transition region 506 of a flow path 702 dimensioned to increase the cooling rate of the intermediate extrudate, to reduce the average velocity of the intermediate extrudate expelled from the extruder 100, and to begin forming the intermediate extrudate. In a general embodiment, the transition region 506 has a length L, an inlet 508 with a first cross-sectional area, and an outlet 510 with a second cross-sectional area that is larger than the first cross-sectional area. Additionally, the transition region 506 has sidewalls 512 connecting the inlet 508 and the outlet 510, the sidewalls 512 defining a shape that has a cross-sectional profile selected to provide a minimum cross-sectional expansion ratio of 2× for any continuous length L/2 over the entire length L of the transition region 506.

A cross-sectional expansion ratio is calculated by taking the ratio of a downstream cross-sectional area relative to an upstream cross-sectional area. Thus, the cross-sectional expansion ratio of 2× for any continuous length L/2 over the entire length L of the transition region 506 can be calculated by determining an upstream cross-sectional area at an arbitrary location along the cross-sectional profile of the transition region 506 and then determining a downstream cross-sectional area at a location that is L/2 from the arbitrary starting location, then calculating the ratio of the downstream cross-sectional area relative to the upstream cross-sectional area. Alternatively, the cross-sectional expansion ratio can be calculated by determining a downstream cross-sectional area at an arbitrary location along the cross-sectional profile of the transition region 506 and then determining an upstream cross-sectional area at a location that is L/2 from the arbitrary starting location, then calculating the ration of the downstream cross-sectional area relative to the upstream cross-sectional area.

As an example, if the transition region 506 has an inlet 508 with cross-sectional area of 126 mm2 and a cross-sectional area of 504 mm2 at a distance of L/2 mm from the inlet 508, then the cross-sectional expansion ratio of 4×. Likewise, if the transition region 506 has a cross-sectional area of 145 mm2 at ((L/2)−5) mm from the inlet 508 and a cross-sectional area of 870 mm2 at a distance of ((L/2)+5) mm from the inlet 508, the cross-sectional expansion ratio is 6×.

In a non-limiting embodiment, a transition region 506 of an exemplary flow path 702 for processing an intermediate extrudate has a cross-sectional expansion ratio of at least 2× for any continuous length L/2 over the entire length L of the transition region 506. Further, the transition region 506 has an expansion ratio of at least 4× from the inlet 508 and L/2 mm from the inlet 508, and an expansion ratio of at least 12× over the entire length L mm of the transition region 506.

In the non-limiting embodiment shown in FIGS. 5A-5E, the inlet 508 of the transition die 504 has a circular cross-section and the outlet 510 of the transition die 504 has an elliptical cross-section. In a more particular embodiment, the transition region 506 has a departure angle of 20.8 degrees when measured from a vertex at the center of the inlet 508 to major diameter of the outlet 510.

FIG. 6A-6E are various views of a body module of the cooling die according to an illustrative embodiment. FIG. 6A is a perspective view of the body module 600, FIG. 6B is a side elevation view of the base module 600, FIG. 6C is a view of the base module 600 taken along line A-A in FIG. 6B, FIG. 6D is a plan view of the base module 600, and FIG. 6E is an elevation view of an end of the base module 600.

The base module 600 is generally formed from an enclosure 602 that houses a body die 604. In this illustrative embodiment, the enclosure 602 includes an upper enclosure 602a and a lower enclosure 602b. The enclosure 602 can be secured together using conventional fasteners. In this illustrative embodiment, the upper enclosure 602a and lower enclosure 602b are bolted together. Separability of the enclosure 602 facilitates repair, replacement, and/or cleaning of the body die 604.

In this illustrative embodiment, the body die 604 defines a cavity 606 that forms a portion of the forming region 607 of the flow path 702. A plurality of body dies 604 can be arranged in series so that their respective cavities 606 can be aligned to form forming region 607 having a desired length. In some embodiments, the forming region 607 is dimensioned to cause the intermediate extrudate to have a generally elliptical (e.g., regular ellipse), elliptical-like (e.g., irregular ellipse) or tear-drop shaped cross-section and to cause the intermediate extrudate to assume a generally serpentine or sinusoidal flow through the forming region 607, as can be seen in FIGS. 8 and 9. The serpentine flow through the forming region 607 increases the surface area to volume ratio of the intermediate extrudate flowing through the cooling die 300. The increased surface area to volume ratio increases the rate of cooling of the intermediate extrudate, which reduces the amount of moisture lost to evaporation as the finished extrudate is expelled from a terminal end of the cooling die 300. In some embodiments, the folded or layered structure of the intermediate extrudate traps moisture in the folds.

In this illustrative embodiment in FIG. 6, the inlet 508 and the outlet 610 of the partial forming region 607 both have an elliptical cross-section that can be the same as the outlet 610 of the transition region 606. The concatenation of two or more body modules 600 to align two or more body dies 604 creates an elongated forming region 607 with a desired length.

FIGS. 7 and 8 are images of an intermediate extrudate flowing through the flow path of a cooling die according to an illustrative embodiment. FIG. 7 is a plan view of a cooling die depicting an intermediate extrudate conveyed through a flow path at a mass flow rate of about 5 kg/hr, and FIG. 8 is a plan view of a cooling die depicting an intermediate extrudate conveyed through the same flow path and at the same process parameters except for the mass flow rate, which was increased to about 10 kg/hr.

FIG. 7 depicts a cooling die 300 formed from a plurality of cooling die modules, e.g., one base module 500 and three body modules 600. The upper enclosures for each of the cooling die modules have been removed to show the travel of an intermediate extrudate 700 through the flow path 702. The flow path 702 is formed from a transition region 506 that transitions the cross-sectional area of the inlet 508 of the flow path 702 to the cross-sectional area at the interface 706 between the outlet 510 of transition region 506 and the inlet 508 of the forming region 607. The transition region 506 can have a selected cross-sectional profile that provides the desired cross-sectional expansion ratio as previously described. In this illustrative embodiment, the forming region 607 has a constant cross-sectional profile from end to end. However, in other embodiments, the flow path through the cooling die can have a constant cross-sectional profile from the inlet to the outlet; or a cross-sectional profile that increases and/or decreases along its length.

The flow path 702 is dimensioned to cause the intermediate extrudate 700 to assume a generally serpentine path through the cooling die 300. The serpentine path imparts folds 704 to the intermediate extrudate 700. The serpentine path is illustrated by the arrow 706 superimposed onto the intermediate extrudate 700.

When the intermediate extrudate 700 is conveyed through the flow path 702 of the cooling die 300 at a higher mass flow rate, the folded structure of the intermediate extrudate is more tightly compacted, as can be seen from the intermediate extrudate 800 shown in FIG. 8. To compare the effect of the mass flowrate of intermediate extrudate through a flow path 702, various measurements were taken with trial runs of intermediate extrudate at different mass flowrates, e.g., at 5 kg/hr, 10 kg/hr, and 15 kg/hr. These results are shown in some of the graphs shown in FIGS. 9-14. To facilitate the discussion of the results, FIG. 9 includes delineations corresponding to the interfaces between each of the cooling die modules relative to the overall length L of the flow path 702. Those delineations are reproduced on selected graphs shown in FIGS. 9-14.

FIG. 9 is a multivariable graph depicting various parameters as function of distance for a system according to an illustrative embodiment. Graph 900 presents data showing the average velocity of intermediate extrudate flowing through the flow path 702 as a function of distance from an inlet 508, and a ratio of cross-sectional area as a function of distance from an inlet 508.

Graph 900 includes a first line 902 showing the cross-sectional area (cm2) as a function of distance from the inlet 508. The behavior of the line shows that the cross-sectional area of the flow path 702 increases over a length of the transition region 506 from an initial value of 1.3 cm2 to a final value of 15.3 cm2, and then remains constant over the forming region 607. The line 902 represents the cross-sectional profile of the flow path 702 dimensioned as shown in FIG. 7. Line 904 shows the cross-sectional expansion ratio as a function of distance from the inlet 508. Line 904 follows the same trend as line 902 but reaches a maximum value of 12. Thus, the cross-sectional expansion ratio is related to the cross-sectional profile of the flow path 702.

Graph 900 also includes lines 906, 908, and 910, which shows the average velocity of an intermediate extrudate as a function of distance from an inlet 508 at average velocities of 15 kg/hr, 10 kg/hr, and 5 kg/hr, respectively. The dimensions of the transition region 506 reduced the average velocity of the intermediate extrudate flowing through the flow path 702, which in turns allows for an extended cooling time. The constant diameter between the inlet 508 to the outlet 510 of the forming region 607 results in the constant average velocity over the forming region 607. In addition, each of the average velocities depicted in the graph 900 maintain a predictable curvilinear relationship relative to one another throughout the length of the flow path 702.

Although the flowchart 900 in FIG. 9 only depicts mass flowrates of 5 kg/hr, 10 kg/hr, and 15 kg/hr, the mass flowrate can be between 1-750 kg/hr, or more particularly between 1-200 kg/hr. In some embodiments, the mass flowrates can be between 1-100 kg/hr, 1-90 kg/hr, 1-80 kg/hr, 1-70 kg/hr, 1-60 kg/hr, 1-50 kg/hr, 1-40 kg/hr, 1-30 kg/hr, or between 1-20 kg/hr. In other embodiments, the mass flowrates can be between 2-20 kg/hr, 2-19 kg/hr, 2-18 kg/hr, 2-17 kg/hr, 2-16 kg/hr, or 2-15 kg/hr. In a particular embodiment, the mass flowrate is between 5-10 kg/hr. In another embodiment, the mass flowrate can be between 45-55 kg/hr or between 40-60 kg/hr.

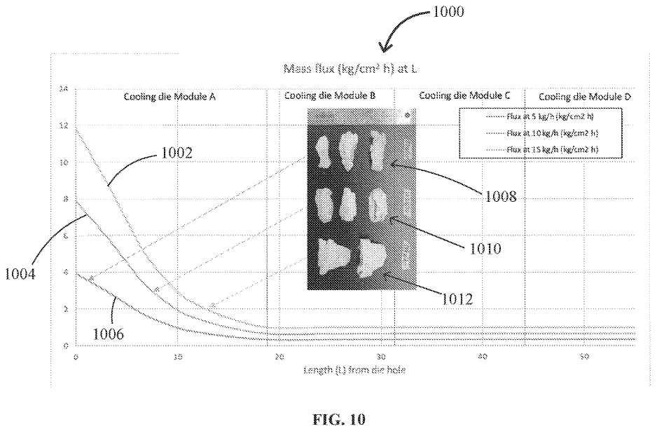

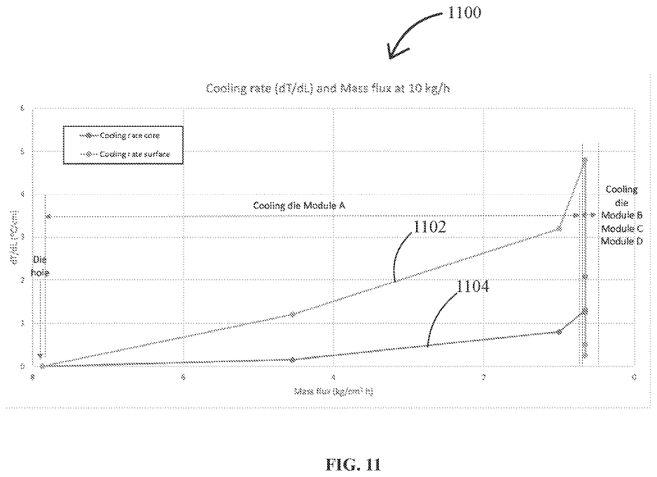

FIG. 10 is a graph depicting mass flux of intermediate extrudate through the flow path of the cooling die in accordance with an illustrative embodiment. As used herein, mass flux is defined as throughput per cross-sectional area and is represented in Graph 1000 in units of kg/ch2-hr. Graph 1000, which represents mass flux as a function of length from an inlet 508 of a flow path 702, is provided to generalize the velocity reduction of intermediate extrudate for cooling dies defining flow paths of varying dimensions. In particular, the velocity of the intermediate extrudate (kg/m) is converted to a mass flux (kg/cm2 hr) through the cross-sectional area (cm2) of the flow path 702.

In graph 1000, each of the lines represents a different mass flux. Line 1002 corresponds to a mass flux for the 15 kg/hr flow rate, line 1004 corresponds to a mass flux for the 10 kg/hr flow rate, and line 1006 corresponds to the mass flux for the 5 kg/hr flow rate. Extrudates 1008, 1010, and 1012 formed from the various flow rates are also shown superimposed onto the graph 1000. The extrudates 1008 and 1010, which are formed from the 5 kg/hr and 10 kg/hr flow rates, respectively, have well-defined folds and are preferable. The extrudate 1012, which is formed from a flow rate of 15 kg/hr, has less well-defined folds and may be acceptable in some applications. Thus, an extrudate formed in accordance with various aspects of this disclosure may be formed with a mass flux that is less than 15 kg/cm2, 14 kg/cm2, 13 kg/cm2, or 12 kg/cm2 hr, at least at the inlet 508, and a mass flux that is lower than 2 kg/cm2 hr at the outlet 510 of the transition region 506. Further, in one or more embodiments, the mass flux at the inlet 508 should be at about 4× greater than the mass flux at the outlet 510. In some embodiments, the mass flux at the inlet 508 should be about 8× greater than the mass flux at the outlet 610. In some other embodiments, the mass flux at the inlet 508 should be about 12× greater than the mass flux at the outlet 610.

FIG. 11 is a graph depicting a cooling rate versus mass flux through a flow path of the cooling die in accordance with an illustrative embodiment. The cooling rate is defined as a reduction of temperature per unit length of the cooling die 300. In graph 1100, the cooling rate is in units of ° C./cm.

Mass flux in kg/cm2 hr is shown on the X-axis. Values for mass flux are decreasing because the flow dimensions of the transition region 506 reduce the flow rate and thus the mass flux of intermediate extrudate through the upstream end of the flow path 702. A length of the base module 500 (i.e., cooling die module A) and the body modules 600 (i.e., cooling die modules B-D) are superimposed over the graph 1100 to illustrate the cooling rate as a function of position within the flow path 702.

The upper line 1102 represents the cooling rate calculated at the surface of the intermediate extrudate and the lower line 1104 represents the cooling rate calculated at the core of the intermediate extrudate. The exterior surface of the intermediate extrudate experiences an increasing cooling rate over a length of the transition region 506 and peaks at a value greater than 4° C./cm. A higher cooling rate is achieved with decreasing mass flux values, which is attributable to the cross-sectional profile of the transition region 506.

The interior surface of the intermediate extrudate also experiences an increasing cooling rate over a length of the transition region 506 and peaks at a value that is greater than 1° C./cm. As previously concluded, the higher cooling rate is achieved with decreasing mass flux values attributable to the cross-sectional profile of the transition region 506.

FIG. 12 is a graph depicting temperature and cooling rate as a function of position in accordance with an illustrative embodiment. Graph 1200 depicts four lines 1202, 1204, 1206, and 1208. Line 1202 represents temperature of the core of the intermediate extrudate as a function of distance from the inlet 508. The decreasing line 1202 shows that a temperature of the core of the intermediate extrudate continues to decrease over the entire length of the flow path 702.

Line 1204 represents temperature of the surface of the intermediate extrudate as a function of distance from the inlet 508. The line 1204 has a steeper, decreasing slope than line 1202 in the transition region 506, which indicates that the surface undergoes a greater heat loss in the upstream end of the flow path 702 as compared to the core. The greater heat loss continues at an upstream end of the forming region 607, i.e., in the first body module 600 (Cooling die Module B), before tapering off over the remainder of the forming region 607.

Line 1206 represents a cooling rate at a surface of the intermediate extrudate as a function of distance from the inlet 508. The data represented by the line 1206 indicates that the greatest heat loss, i.e., the greatest amount of cooling, is experienced throughout the transition region 506 and in the upstream end of the forming region 607, i.e., within the first body module 600 (Cooling die Module B). Lines 1204 and 1206 are inversely related.

Line 1208 represents a cooling rate in the core of the intermediate extrudate as a function of distance from then inlet 508. The behavior of line 1208 shows that the cooling rate is negligible in the core of the intermediate extrudate.

FIG. 13 is a graph depicting the temperature gradient of an intermediate extrudate as a function of distance in accordance with an illustrative embodiment. Graph 1300 includes line 1302 that represents the temperature gradient between the surface of the intermediate extrudate and the core. The line 1302 indicates that a significant temperature gradient is manifested in the intermediate extrudate as it is conveyed through flow path 702. At the flow rate of 10 kg/hr the peak temperature gradient is found at the upstream end of the forming region 607, i.e., in the first body module 600 (Cooling die Module B). Lower flow rates pushed the peak closer to the transition region 506 while higher flow rates pushed the peak towards the end of the forming region 607.

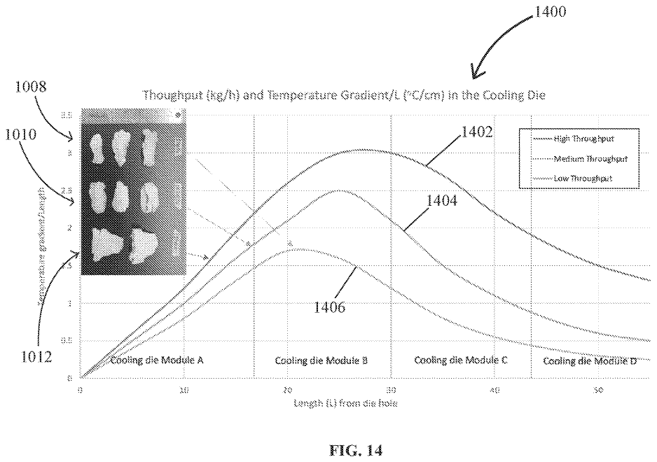

FIG. 14 is a graph depicting the temperature gradient of an intermediate extrudate as a function of position for varying throughput in accordance with an illustrative embodiment. Graph 1400 includes line 1402, line 1404, and line 1406. Line 1402 represents temperature gradient as a function of distance from an inlet 508 of a flow path 702 for high throughput, i.e., at a flow rate of 15 kg/hr; line 1404 represents temperature gradient as a function of distance from an inlet 508 for moderate throughput, i.e., at a flow rate of 10 kg/hr; and line 1406 represents temperature gradient as a function of distance from an inlet 508 for low throughput, i.e., at a flow rate of 5 kg/hr. Higher throughput is correlated with a higher temperature gradient and lower residence times in the cooling die 300, which results in the formation of an extrudate with less well-defined folds and less desirable organoleptic properties.

From the data represented in the graphs shown in FIGS. 9-14, a first conclusion can be reached that the flow path 702 defined by the cooling die 300 should be dimensioned to increase the cooling efficiency of the cooling die via a length of the flow path 702, a volumetric expansion of the flow path 702, a sufficiently high cooling rate (° C./cm) at least at the surface of the intermediate extrudate, and a reduction of the average velocity, i.e., flow rate, of the intermediate extrudate. Reduction of the average velocity of the extrudate can be controlled by reducing the mass flux (kg/cm2 hr) and increasing the cooling rate (° C./cm).

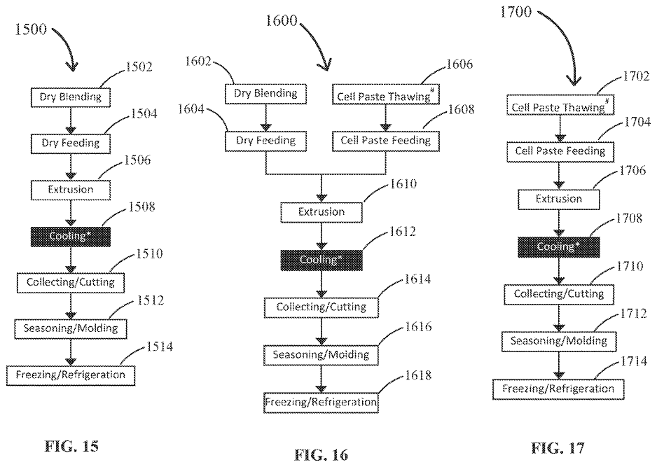

FIG. 15 is a flowchart of a process for forming an extruded product from a dry mix in accordance with an illustrative embodiment. At least some of the steps of flowchart 1500 can be carried out in an extruder, such as extruder 100 in FIG. 1. The flowchart 1500 begins at step 1502 by dry blending dry mix ingredients. The dry mix ingredients can include the dry mix ingredients identified in Tables 2-6 and one or more ingredients in Table 11. In a non-limiting embodiment, the dry mix ingredients are individually weighed and combined into a mixer, e.g., a Tinso Mixer Bowl, and mixed at speed for a sufficient length of time for complete mixing, e.g., 1-3 minutes. The dry mix can be transferred to a feeder, such as feeder 106 for controlled introduction into the extruder 100.

Dry feeding is performed in step 1504. Before, during, or after the dry feeding step 1502, a source of moisture (i.e., wet feed) can be introduced into the barrel of the extruder. The wet feed can be formed entirely or primarily from water in the form of a liquid or gas, i.e., steam. In a non-limiting embodiment, the wet feed is introduced into the barrel first and the dry feeding in step 1502 is initiated after a steady flow of the wet feed is achieved. In a particular embodiment, the dry feed step 1502 is initiated 3-5 seconds after the wet feed is started.

Extrusion is performed in step 1506. Extrusion can be performed in an extruder barrel and die such as extruder barrel 200 and connecting die 210 in FIG. 2. In a non-limiting embodiment, the extruder barrel 200 can be configured so that the set of screws has an operating speed of 900 RPM and so that the extruder has the following operating temperature profile: Zone 1 at 50° C., Zone 2 at 105° C., Zone 3 at 130° C., Zone 4 at 130° C., and Zone 5 at 80° C. In this non-limiting embodiment, once the extrudate begins to exit the cooling die, the screw speed can be brought up to the operating speed from an initial screw speed, e.g., 400 RPM, and the temperature of the extrudate barrel can be brought up to the operating temperature profile from an initial temperature profile, e.g., room temperature.

The feed rates for the dry mix feed and wet feed can be selected based, at least in part, on the process parameters, and extruder and cooling die dimensions to create an extrudate with the desired organoleptic properties. In a non-limiting embodiment, the feed rate of the dry mix is set to an initial dry mix feed rate and increased to the operational dry mix feed rate once the extrudate begins to exit the cooling die. In a non-limiting embodiment, the dry mix feed rate is increased from an initial dry mix feed rate of 2 kg/hr to the operational dry mix feed rate of 3.5 kg/hr, and the wet mix feed rate is kept constant at a wet mix feed rate of 6.5 kg/hr.

Cooling of the intermediate extrudate is performed in step 1508. The intermediate extrudate can be cooled according to the cooling rate described in FIG. 11 using the exemplary cooling die 300. The extrudate collected at the outlet of the cooling die 300 can be optionally cut in step 1510, seasoned and optionally molded in step 1512, and cooled for long-term storage in step 1514. In some embodiments, the processed extrudate is refrigerated or frozen in cooling step 1514.

FIG. 16 is a flowchart of a process for forming an extruded product from a dry mix and cell paste in accordance with an illustrative embodiment. At least some of the steps of flowchart 1600 can be carried out in an extruder, such as extruder 100 in FIG. 1.

Flowchart 1600 is like flowchart 1600 except that the dough processed into an intermediate extrudate is formed from a mixture of dry mix and cell paste. Thus, before the extrusion step 1610, e.g., either before, during, or after the dry blending step 1602, cell paste is optionally thawed in step 1606. Thawing is necessary if the cell paste is stored in a frozen or partially frozen state, or at a temperature that prevents the cell paste from being conveyed into the extruder at the desired flow rate. In a non-limiting embodiment, thawing of frozen cell paste can be achieved by the following steps: (1) transfer cell paste from a freezer to a food safe container large enough to fit the cell paste and a water bath; (2) vacuum seal the cell paste to prevent leakage; (3) provide ambient temperature to the cell paste; (4) transfer cell paste into a sealable sterile container in an ice water bath and store in the refrigerator until the extrusion cooking process is ready to begin; and (5) submerge the cell paste reservoir in an ice bath during the extrusion cooking process.

The wet mix is introduced into the extruder in the cell paste feeding step 1608. In some embodiments, the cell paste feeding step 1608 includes an initial step of priming the extruder system with a wet feed until the steady state operation of the extruder system at the requisite processing parameters has been achieved. Thereafter, the wet feed can be substituted with the cell paste.

The remaining steps of flowchart 1600, namely the dry feeding step 1604, the extrusion step 1610, the cooling step 1612, the collecting/cutting step 1614, the seasoning/molding step 1616, and the freezing/refrigerating step 1618 are the same as the dry feeding step 1604, the extrusion step 1606, the cooling step 1608, the collecting/cutting step 1610, the seasoning/molding step 1612, and the freezing/refrigerating step 1614 from flowchart 1600, respectively.

FIG. 17 is a flowchart of a process for forming an extruded product from cell paste in accordance with an illustrative embodiment. At least some of the steps of flowchart 1700 can be carried out in an extruder, such as extruder 100 in FIG. 1.

The steps of flowchart 1700 are analogous to certain steps in flowchart 1700. For example, cell paste thawing in step 1702 is analogous to cell paste thawing in step 1706 in flowchart 1700. Likewise, cell paste feeding in step 1704, extrusion in step 1706, cooling in step 1708, collecting/cutting in step 1710, seasoning/molding in step 1712, and freezing/refrigerating in step 1714 are analogous to cell paste feeding in step 1708, extrusion in step 1710, cooling in step 1712, collecting/cutting in step 1714, seasoning/molding in step 1716, and freezing/refrigerating in step 1718 in FIG. 17, respectively.

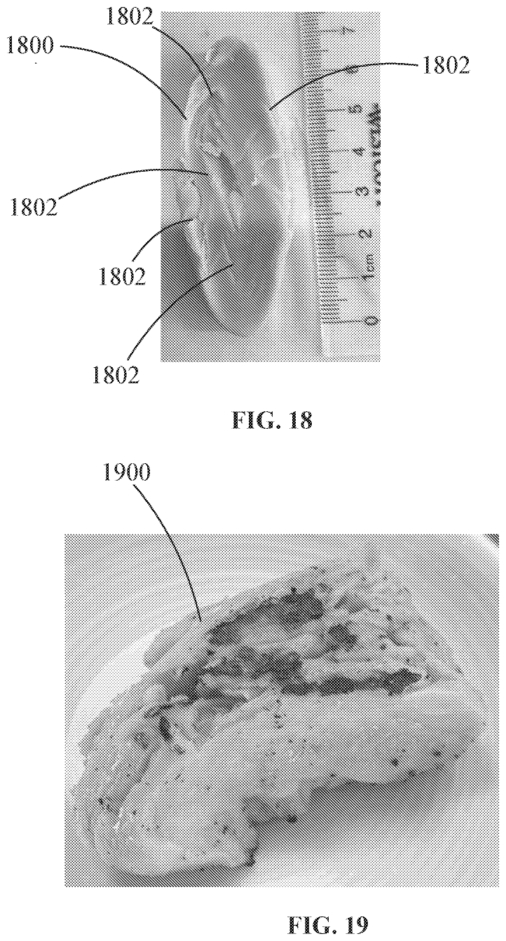

FIG. 18 is a picture of an extrudate formed in accordance with an illustrative system and method. The extrudate 1800 has a generally elliptical (e.g., regular ellipse), elliptical-like (e.g., irregular ellipse) or tear-drop cross-section and includes folds 1802 disposed at the surface of the extrudate 1800 and into the core of the extrudate 1800.

FIG. 19 is a picture of extrudate formed in accordance with an illustrative system and method and cooked to form an imitation meat product. The imitation meat product 1900 has a fibrous texture attributed to its folded structure, which provides the desired organoleptic properties.

The following descriptive embodiments are offered in further support of the aspects of this disclosure.

In a first embodiment, aspects of the present disclosure are directed to an apparatus for forming an extrudate. The apparatus can be a cooling die that has a body defining a flow path extending from an inlet at an upstream end of the body to an outlet at a downstream end of the body. The inlet has a first cross-sectional area, and the outlet has a second cross-sectional area that is larger than the first cross-sectional area. Additionally, the flow path can include a transitional region at the upstream end of the body with a length L and a minimum cross-sectional expansion ratio of at least 2× for any continuous length L/2 over the length L of the transitional region, and the flow path includes a forming region extending from the transitional region to the outlet.

In another aspect of the first embodiment, the apparatus can be a cooling die that has a body defining a flow path extending from an inlet at an upstream end of the body to an outlet at a downstream end of the body. The inlet has a first cross-sectional area, and the outlet has a second cross-sectional area that is larger than the first cross-sectional area. Additionally, the flow path can include a transitional region at the upstream end of the body with a length L and a minimum cross-sectional expansion ratio of at least 2× for any continuous length L/2 over the length L of the transitional region, and the flow path includes a forming region extending from the transitional region to the outlet. The apparatus also include one or more limitations selected from the following list:
wherein the transitional region has a first cross-sectional expansion ratio of 8× calculated from the inlet to a distance L/2 from the inlet;
wherein the transitional region has a second cross-sectional expansion ratio of 12× calculated from the inlet to the outlet;
a cooling system coupled with the body, wherein the cooling system is configured to cool an intermediate extrudate flowing through the flow path, and wherein the cooling system is configured to provide a selected cooling rate;
wherein the cooling system is configured to provide a first cooling rate of at least 4° C./cm to an exterior of the intermediate extrudate at an end of the transition region;
wherein the cooling system is configured to provide a second cooling rate of at least 1° C./cm to an interior of the intermediate extrudate at an end of the transition region;
wherein the cooling system is configured provide the first cooling rate and the second cooling rate to the intermediate extrudate based on a mass flux through the transitional region, wherein the mass flux is less than 12 kg/cm2 at the inlet and less than 2 kg/cm2 at an end of the transitional region;
wherein the mass flux at the inlet is about 4× higher than the mass flux at the end of the transition region;
wherein the mass flux at the inlet is about 8× higher than the mass flux at the end of the transition region;
wherein the mass flux at the inlet is about 12× higher than the mass flux at the end of the transition region; and
wherein the body includes a plurality of openings disposed in one or more sidewalls of the body, the body defines a set of channels extending throughout a width of the body and fluidically connected to the plurality of openings, and selective obstruction of at least some of the openings in the plurality of openings while selective introduction of cooling water into at least some other openings in the plurality of openings causes the cooling water to flow through one of a plurality of different cooling water flow paths.

In some embodiments, the texture of the extrudate is one or more of following:
wherein the texture of the extrudate is a cohesiveness between 0.1 and <1/cm²;
wherein the texture of the extrudate is an elasticity between 0.1 and <1/cm²;
wherein the texture of the extrudate is a chewiness between 100-1500 g/cm²;
wherein the texture of the extrudate is an anisotropic index between 0.5-3; and
wherein the texture of the extrudate is a firmness between 100-1500 g/cm².

In other embodiments, aspects of the present disclosure are also directed to an extrudate formed from a mixture of cultivated animal cells and a proteinaceous ingredient. The extrudate includes an elongated body with a generally elliptical (e.g., regular ellipse), elliptical-like (e.g., irregular ellipse) or tear-drop cross-section. The elongated body includes irregular folds at a surface of the elongated body and disposed throughout a volume of the elongated body, and the extrudate has a texture that is similar to a farm-raised animal counterpart.

In other embodiments, the extrudate formed from a mixture of cultivated animal cells and a proteinaceous ingredient includes an elongated body with a generally elliptical (e.g., regular ellipse), elliptical-like (e.g., irregular ellipse) or tear-drop shaped cross-section. The elongated body includes irregular folds at a surface of the elongated body and disposed throughout a volume of the elongated body, and the extrudate has a texture that is similar to a farm-raised animal counterpart. The extrudate also includes one or more limitations selected from the following list:
wherein the farm-raised animal counterpart is poultry and wherein the cultivated animal cells are poultry animal cells;
wherein the farm-raised animal counterparty is one of beef, pork, fish, and wherein the cultivated animal cells are bovine animal cells, porcine animal cells, and fish animal cells, respectively;
wherein the texture of the extrudate is a cohesiveness between 0.1 and <1/cm2;
wherein the texture of the extrudate is an elasticity between 0.1 and <1/cm2;
wherein the texture of the extrudate is a chewiness between 100-1500 g/cm2;
wherein the texture of the extrudate is an anisotropic index between 0.5-3;
wherein the texture of the extrudate is a firmness between 100-1500 g/cm2;
wherein the extrudate is formed from a formulation that includes the mixture of the cultivated animal cells and the plant-based proteins, the cultivated animal cells are in an amount between 35-95 wt % of the formulation, the plant-based proteins are included in a dry mix in an amount between 25-45 wt % of the formulation, and the dry mix includes the plant-based proteins, a binding ingredient, an emulsifier, and one or more flavorants;
wherein the cultivated animal cells include a moisture content between 85-97 wt %, a protein content between 3-9 wt %, and a fat content less than 3 wt %;
wherein the cultivated animal cells further contains a viscosity between 450-550 cP at 5° C.;
wherein the dry mix contains a moisture content between 3-9 wt %, a protein content between 69-89 wt %, and a bulk density between 0.03-0.06 g/cm3;
wherein the binding ingredient is a modified food starch in an amount between 0.078-0.98 wt % of the formulation;
wherein the emulsifier is soy lecithin in an amount between 0.25-0.45 wt % of the formulation;
wherein the plant-based proteins are in an amount between 23-43 wt % of the formulation, and wherein the plant-based proteins include at least one of soy protein concentrate, soy protein isolate, and wheat protein isolate;
wherein the plant-based proteins include soy protein in an amount between 14-22 wt % of the formulation, and wheat protein isolate in an amount between 10-16 wt % of the formulation; and
wherein the flavorants includes at least one of dehydrated onion, dehydrated garlic, and salt, and wherein the flavorants are included in an amount between 0.84-1.04 wt % of the formulation.

In other embodiments, aspects of the present disclosure are also directed to a method for forming an extrudate from a formulation including cultivated animal cells and a proteinaceous ingredient. The method includes a step of receiving an intermediate extrudate into a flow path of a cooling die. In an exemplary embodiment, the flow path extends from an inlet with a first cross-sectional area at an upstream end of the cooling die to an outlet with a second cross-sectional area at a downstream end of the cooling die. Additionally, the flow path includes a transition region at the upstream end and a forming region at the downstream end. The flow path is dimensioned so that the intermediate extrudate is received at the inlet at a first mass flux and crosses an interface between the transition region and the forming region at a second mass flux that is at least 4× less than the first mass flux. The method also includes cooling the intermediate extrudate at a cooling rate that provides a first temperature reduction per unit length of at least 4° C./cm and expelling the intermediate extrudate from the cooling die to form the extrudate.

In other embodiments, the method includes a step of receiving an intermediate extrudate into a flow path of a cooling die. In an exemplary embodiment, the flow path extends from an inlet with a first cross-sectional area at an upstream end of the cooling die to an outlet with a second cross-sectional area at a downstream end of the cooling die. Additionally, the flow path includes a transition region at the upstream end and a forming region at the downstream end. The flow path is dimensioned so that the intermediate extrudate is received at the inlet at a first mass flux and crosses an interface between the transition region and the forming region at a second mass flux that is at least 4× less than the first mass flux. The method also includes cooling the intermediate extrudate at a cooling rate that provides a first temperature reduction per unit length of at least 4° C./cm and expelling the intermediate extrudate from the cooling die to form the extrudate. The also includes one or more limitations selected from the following list:
wherein the first mass flux is at least 8× greater than the second mass flux;
wherein the first mass flux is at least 4 kg/cm2 and the second mass flux is less than 2 kg/cm2;
wherein the first mass flux is between 6-10 kg/cm2 and the second mass flux is less than 2 kg/cm2;
wherein the first temperature reduction per unit length of at least 4° C./cm is at a surface of the intermediate extrudate at the interface between the transition region and the forming region;
wherein the cooling rate provides a second temperature reduction per unit length of at least 1° C./cm in a core of the intermediate extrudate;
wherein the cooling rate of the intermediate extrudate peaks in the forming region of the flow path;
wherein the flow path is dimensioned to cause the intermediate extrudate to assume a generally serpentine path through the flow path, and wherein the generally serpentine path imparts irregular folds throughout the intermediate extrudate;
wherein the intermediate extrudate is formed from a dough including cultivated animal cells and plant-based proteins; and
wherein the flow path includes a transitional region at the upstream end of the body with a length L and a minimum cross-sectional expansion ratio of at least 2× for any continuous length L/2 over the length L of the transitional region, and the flow path includes a forming region extending from the transitional region to the outlet.

In other embodiments, aspects of the present disclosure are also directed to a system for forming an extrudate. The system includes an extruder barrel housing a set of screws and a set of feed streams coupled to one or more inlets of the extruder barrel. The set of feed streams provide feed material processed within the extruder barrel. The system also includes a cooling die fluidically coupled to an outlet of the extruder barrel, the cooling die having a body defining a flow path extending from an inlet at an upstream end of the body to an outlet at a downstream end of the body. Additionally, the inlet has a first cross-sectional area, the outlet has a second cross-sectional area that is larger than the first cross-sectional area, the flow path includes a transitional region at the upstream end of the body with a length L and a minimum cross-sectional expansion ratio of at least 2× for any continuous length L/2 over the length L of the transitional region, and the flow path includes a forming region extending from the transitional region to the outlet.

In other embodiments, the system includes an extruder barrel housing a set of screws and a set of feed streams coupled to one or more inlets of the extruder barrel. The set of feed streams provide feed material processed within the extruder barrel. The system also includes a cooling die fluidically coupled to an outlet of the extruder barrel, the cooling die having a body defining a flow path extending from an inlet at an upstream end of the body to an outlet at a downstream end of the body. Additionally, the inlet has a first cross-sectional area, the outlet has a second cross-sectional area that is larger than the first cross-sectional area, the flow path includes a transitional region at the upstream end of the body with a length L and a minimum cross-sectional expansion ratio of at least 2× for any continuous length L/2 over the length L of the transitional region, and the flow path includes a forming region extending from the transitional region to the outlet. The system also includes one or more limitations selected from the following list:
wherein the extruder barrel is configured with a temperature profile having at least five different temperature zones;
wherein the transitional region has a first cross-sectional expansion ratio of 8× calculated from the inlet to a distance L/2 from the inlet;
wherein the transitional region has a second cross-sectional expansion ratio of 12× calculated from the inlet to the outlet;
a cooling system coupled with the body, wherein the cooling system is configured to cool an intermediate extrudate flowing through the flow path, and wherein the cooling system is configured to provide a selected cooling rate;
wherein the cooling system is configured to provide a first cooling rate of at least 4° C./cm to an exterior of the intermediate extrudate at an end of the transition region;
wherein the cooling system is configured to provide a second cooling rate of at least 1° C./cm to an interior of the intermediate extrudate at an end of the transition region;
wherein the cooling system is configured provide the first cooling rate and the second cooling rate to the intermediate extrudate based on a mass flux through the transitional region, wherein the mass flux is less than 12 kg/cm2 at the inlet and less than 2 kg/cm2 at an end of the transitional region;
wherein the mass flux at the inlet is at least 4 times higher than the mass flux at the end of the transition region;
wherein the mass flux at the inlet is at least 8 times higher than the mass flux at the end of the transition region;
wherein the mass flux at the inlet is at least 12 times higher than the mass flux at the end of the transition region; and
wherein the body includes a plurality of openings disposed in one or more sidewalls of the body, the body defines a set of channels extending throughout a width of the body and fluidically connected to the plurality of openings, and selective obstruction of at least some of the openings in the plurality of openings while selective introduction of cooling water into at least some other openings in the plurality of openings causes the cooling water to flow through one of a plurality of different cooling water flow paths.

In other embodiments, aspects of the present disclosure are also directed to an apparatus for forming an extrudate. The apparatus includes a body defining a flow path extending from an inlet at an upstream end of the body to an outlet at a downstream end of the body. The inlet has a first cross-sectional area with a first geometric shape, the outlet has a second cross-sectional area with a second geometric shape, and the second cross-sectional area is larger than the first cross-sectional area and the second geometric shape is elliptical (e.g., regular ellipse), elliptical-like (e.g., irregular ellipse) or tear-drop.

In other embodiments, the apparatus includes a body defining a flow path extending from an inlet at an upstream end of the body to an outlet at a downstream end of the body. The inlet has a first cross-sectional area with a first geometric shape, the outlet has a second cross-sectional area with a second geometric shape, and the second cross-sectional area is larger than the first cross-sectional area and the second geometric shape is an elliptical (e.g., regular ellipse), elliptical-like (e.g., irregular ellipse) or tear-drop. The apparatus also includes one or more limitations selected from the following list:
wherein the first geometric shape is a circle;
wherein the flow path includes a transitional region with a circular cross-section at a first end and an elliptical cross-section at a second end;
wherein the flow path includes a forming region between the second end of the transitional region and the outlet of the flow path;
wherein the elliptical (e.g., regular ellipse), elliptical-like (e.g., irregular ellipse) or tear-drop shaped cross-section at the second end and the second geometric shape of the outlet have the same dimensions;
wherein the elliptical (e.g., regular ellipse), elliptical-like (e.g., irregular ellipse) or tear-drop has a major diameter and a minor diameter, and wherein the major diameter is at least 1.5× larger than the minor diameter;
wherein the elliptical (e.g., regular ellipse), elliptical-like (e.g., irregular ellipse) or tear-drop has a major diameter and a minor diameter, and wherein the major diameter is at least 2× larger than the minor diameter;
wherein the wherein the elliptical (e.g., regular ellipse), elliptical-like (e.g., irregular ellipse) or tear-drop has a major diameter and a minor diameter, and wherein the major diameter is about 3× larger than the minor diameter; and
wherein the second cross-sectional area is at least 10× greater than the first cross-sectional area.

### III. Formulations

Formulations or food products from formulations containing cultivated animal cells are described herein. In some embodiments, the cultivated animal cells are available or formulated as a cell paste. In certain embodiments, the formulation or food product has a wet cell paste content of at least 100 wt %, 90 wt %, 80 wt %, 75 wt %, 70 wt %, 65 wt %, 60 wt %, 50 wt %, 40 wt %, 35 wt %, 25 wt %, 15 wt %, 10 wt %, 5 wt %, 4%, 3%, 2%, or 1 wt %. In certain embodiments, the formulation or food product has a wet cell paste content of between 3%-10%, 4%-10%, 5%-10%, 3%-20 wt %, 5%-20%, 10%-20%, 15%-20%, 20-30 wt %, 30-40 wt %, 40-50 wt %, 60-70 wt %, 80-90 wt %, or 90-100 wt %. In certain embodiments, the formulation or food product contains a wet cell paste content of between 2-5 wt %, 5-10 wt %, 10-15 wt %, 15-20 wt %, 20-25 wt %, 25-30 wt %, 30-35 wt %, 35-40 wt %, 40-45 wt %, 45-50 wt %, 50-55 wt %, 55-60 wt %, 65-70 wt %, 70-75 wt %, 75-80 wt %, 80-85 wt %, 85-90 wt %, or 90-95 wt %.

In certain embodiments, the composition contains a pulse protein content of at least 99%, 98%, 97%, 96%, 95%, 90%, 85%, 80%, 75 wt %, 70 wt %, 60 wt %, 50 wt %, 40 wt %, 30 wt %, 25 wt %, 20 wt %, 15 wt %, 10 wt %, 5 wt %, or 3 wt %. In certain embodiments, the formulation or food product has a pulse protein content of between 3%-5%, 3%-10%, 5%-10%, 10-20 wt %, 20-30 wt %, 30-40 wt %, 40-50 wt %, 60-70 wt %, 80-90 wt %, or 90-95 wt %. In certain embodiments, the formulation or food product contains a pulse protein content of at least 2 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt % 95 wt %, 96%, 97%, 98%, or 99%. In certain embodiments, the formulation or food product contains a pulse protein content of between 2-5 wt %, 5-10 wt %, 10-15 wt %, 15-20 wt %, 20-25 wt %, 25-30 wt %, 30-35 wt %, 35-40 wt %, 40-45 wt %, 45-50 wt %, 50-55 wt %, 55-60 wt %, 65-70 wt %, 70-75 wt %, 75-80 wt %, 80-85 wt %, 85-90 wt %, or 90-95 wt %, In some embodiments, the pulse protein is a mung bean protein.

In certain embodiments, the formulation or food product contains a fat content of at least 50 wt %, 40 wt %, 30 wt %, 25 wt %, 20 wt %, 15 wt %, 10 wt %, 5 wt %, or 1 wt %. In certain embodiments, the formulation or food product has a fat content of between 10-20 wt %, 20-30 wt %, 30-40 wt %, 40-50 wt %, 60-70 wt %, 80-90 wt %, or 90-95 wt %. In certain embodiments, the formulation or food product contains a fat content of at least 1 wt %, a fat content of at least 2 wt %, a fat content of at least 5 wt %, a fat content of at least 7.5 wt %, or a fat content of at least 10 wt %. In certain embodiments, the formulation or food product contains a fat content of at least 15 wt %. In certain embodiments, the formulation or food product contains a fat content of at least 20 wt %. In certain embodiments, the formulation or food product contains a fat content of at least 25 wt %. In certain embodiments, the formulation or food product contains a fat content of at least 27 wt %. In certain embodiments, the formulation or food product contains a fat content of at least 30 wt %. In certain embodiments, the formulation or food product contains a fat content of at least 35 wt %. In certain embodiments, the formulation or food product contains a fat content of at least 40 wt %. In certain embodiments, the formulation or food product contains a fat content of at least 45 wt %. In certain embodiments, the formulation or food product contains a fat content of at least 50 wt %. In certain embodiments, the formulation or food product contains a fat content of at least 55 wt %. In certain embodiments, the formulation or food product contains a fat content of at least 60 wt %. In certain embodiments, the formulation or food product contains a fat content of at least 65 wt %. In certain embodiments, the formulation or food product contains a fat content of at least 70 wt %. In certain embodiments, the formulation or food product contains a fat content of at least 75 wt %. In certain embodiments, the formulation or food product contains a fat content of at least 80 wt %. In certain embodiments, the formulation or food product contains a fat content of at least 85 wt %. In certain embodiments, the formulation or food product contains a fat content of at least 90 wt %. In some embodiments, that formulation or food product contains a fat content of between 1-5 wt %, between 5-10 wt %, between 10-15 wt %, between 15-20 wt %, between 20-25 wt %, between 25-30 wt %, between 30-35 wt %, between 35-40 wt %, between 45-50 wt %, between 50-55 wt %, between 55-60 wt %, between 60-65 wt %, between 65-70 wt %, between 70-75 wt %, between 75-80 wt %, between 80-85 wt %, between 85-90 wt %, or between 90-95 wt %.

In certain embodiments, the formulation or food product contains a water content of at least 50 wt %, 40 wt %, 30 wt %, 25 wt %, 20 wt %, 15 wt %, 10 wt % or 5 wt %. In certain embodiments, the formulation or food product has a water content of between 10-20 wt %, 20-30 wt %, 30-40 wt %, 40-50 wt %, 60-70 wt %, 80-90 wt %, or 90-95 wt %. In certain embodiments, the formulation or food product contains a water content of at least 5 wt %. In certain embodiments, the formulation or food product contains a water content of at least 10 wt %. In certain embodiments, the formulation or food product contains a water to an amount of 15 wt %. In certain embodiments, the formulation or food product contains a water content of at least 20 wt %. In certain embodiments, the formulation or food product contains a water content of at least 25 wt %. In certain embodiments, the formulation or food product contains a water content of at least 30 wt %. In certain embodiments, the formulation or food product contains a water content of at least 35 wt %. In certain embodiments, the formulation or food product contains a water content of at least 40 wt %. In certain embodiments, the formulation or food product contains a water content of at least 45 wt %. In certain embodiments, the formulation or food product contains a water content to an amount of 50 wt %. In certain embodiments, the formulation or food product contains a water content to an amount of 55 wt %. In certain embodiments, the formulation or food product contains a water content to an amount of 60 wt %. In certain embodiments, the formulation or food product contains a water content to an amount of 65 wt %. In certain embodiments, the formulation or food product contains a water content to an amount of 70 wt %. In certain embodiments, the formulation or food product contains a water content to an amount of 75 wt %. In certain embodiments, the formulation or food product contains a water content to an amount of 80 wt %. In certain embodiments, the formulation or food product contains a water content to an amount of 85 wt %. In certain embodiments, the formulation or food product contains a water content to an amount of 90 wt %. In certain embodiments, the formulation or food product contains a water content to an amount of 95 wt %.

In one embodiment, the formulation or food product contains a wet cell paste content between 3 wt %-75 wt %, a plant-based protein content between 15-65 wt %, a fat content between 10-30 wt %, and a water content between 20-50 wt %. The plant-based protein can originate from any one or more of a pulse/legume, grain, seed, nut, or starch. More specifically, the plant-based protein can be protein originating from garbanzo, fava beans, yellow pea, sweet brown rice, rye, golden lentil, chana dal, soybean, adzuki, sorghum, sprouted green lentil, du pung style lentil, and/or white lima bean.

In some embodiments, additional edible ingredients can be used to prepare the formulation of food product. Edible food ingredients include texture modifying ingredients such as starches, modified starches, gums, and other hydrocolloids. Other food ingredients include pH regulators, anti-caking agents, colors, emulsifiers, flavors, flavor enhancers, foaming agents, anti-foaming agents, humectants, sweeteners, and other edible ingredients.

In certain embodiments, the other food ingredients can also include an effective amount of an added preservative in combination with the food combination. Preservatives prevent food spoilage from bacteria, molds, fungi, or yeast (antimicrobials); slow or prevent changes in color, flavor, or texture and delay rancidity (antioxidants); maintain freshness. In certain embodiments, the preservative is one or more of the following: ascorbic acid, citric acid, sodium benzoate, calcium propionate, sodium erythorbate, sodium nitrite, calcium sorbate, potassium sorbate, BHA, BHT, EDTA, tocopherols (Vitamin E) and antioxidants, which prevent fats and oils and the foods containing them from becoming rancid or developing an off-flavor.

The exemplary ingredients listed above included in one of three generally types of different formulations: a dry mix formulation, a cell paste formulation, and a formulation that includes a dry mix combined with cell paste. The formulations can be processed with an extruder system, such as extruder 100 and cooling die 300 to form an imitation meat product that can be in the form of a nugget, tender bites, steak, roast, ground meat, hamburger patties, sausage, or feed stock. Exemplary formulations are included in the tables below. In certain formulations shown below, other proteinaceous ingredients may be included by a corresponding decrease in the amount of listed proteins to achieve a comparable product.

In other embodiments, aspects of this disclosure are directed to a formulation for forming an extrudate with a texture similar to a farm-raised animal counterpart. The formulation can include cultivated animal cells in an amount between 35-95 wt % of the formulation, and a dry mix in an amount between 25-45 wt % of the formulation. The dry mix can include a proteinaceous ingredient, a binding ingredient, an emulsifier, and one or more flavorants.

In other embodiments, the formulation can include cultivated animal cells in an amount between 35-95 wt % of the formulation, and a dry mix in an amount between 25-45 wt % of the formulation. The dry mix can include a proteinaceous ingredient, a binding ingredient, an emulsifier, and one or more flavorants, and one or more limitations selected from the following list:
wherein the cultivated animal cells include a moisture content between 85-97 wt %, a protein content between 3-9 wt %, and a fat content less than 3 wt %;
wherein the cultivated animal cells further contains a viscosity between 450-550 cP at 5° C.;
wherein the dry mix contains a moisture content between 3-9 wt %, a protein content between 69-89 wt %, and a bulk density between 0.03-0.06 g/cm3;
wherein the binding ingredient is a modified food starch in an amount between 0.078-0.98 wt % of the formulation;
wherein the emulsifier is soy lecithin in an amount between 0.25-0.45 wt % of the formulation;
wherein the proteinaceous ingredient is a plant-based protein in an amount between 23-43 wt % of the formulation, and wherein the plant-based proteins include at least one of soy protein and wheat protein isolate;
wherein the plant-based proteins include soy protein in an amount between 14-22 wt % of the formulation, and wheat protein isolate in an amount between 10-16 wt % of the formulation;
wherein the flavorants includes at least one of dehydrated onion, dehydrated garlic, and salt, and wherein the flavorants are included in an amount between 0.84-1.04 wt % of the formulation; and
wherein the farm-raised animal counterpart is one of poultry, beef, pork, or fish, and wherein the cultivated animal cells are poultry animal cells, bovine animal cells, porcine animal cells, and fish animal cells, respectively.

Embodiments of the disclosure can be further understood by the following numbered paragraphs:

1. An apparatus for forming an extrudate, the apparatus including:
a body defining a flow path extending from an inlet at an upstream end of the body to an outlet at a downstream end of the body, wherein:
   the inlet has a first cross-sectional area,
   the outlet has a second cross-sectional area that is larger than the first cross-sectional area,
   the flow path includes a transitional region at the upstream end of the body with a length L and a minimum cross-sectional expansion ratio of at least 2× for any continuous length L/2 over the length L of the transitional region,
   the flow path includes a forming region extending from the transitional region to the outlet, and
optionally a cooling system coupled with the body, wherein the cooling system is configured to cool an intermediate extrudate flowing through the flow path, and wherein the cooling system is configured to provide a selected cooling rate.

2 The apparatus of paragraph 1, wherein the transitional region has a first cross-sectional expansion ratio of 8× calculated from the inlet to a distance L/2 from the inlet.

3. The apparatus of paragraph 2, wherein the transitional region has a second cross-sectional expansion ratio of 12× calculated from the inlet to the outlet.

4. The apparatus of any of paragraphs 1-3, wherein the cooling system is configured to provide a first cooling rate of at least 4° C./cm to an exterior of the intermediate extrudate at an end of the transition region.

5. The apparatus of paragraph 4, wherein the cooling system is configured to provide a second cooling rate of at least 1° C./cm to an interior of the intermediate extrudate at an end of the transition region.

6. The apparatus of paragraph 5, wherein the cooling system is configured to provide the first cooling rate and the second cooling rate to the intermediate extrudate based on a mass flux through the transitional region, wherein the mass flux is less than 12 kg/cm2 at the inlet and less than 2 kg/cm2 at an end of the transitional region, preferably, wherein the mass flux at the inlet is about 4× higher than the mass flux at the end of the transition region or is about 8× higher than the mass flux at the end of the transition region.

7. The apparatus of any one of paragraphs 1-6, wherein: the body includes a plurality of openings disposed in one or more sidewalls of the body; the body defines a set of channels extending throughout a width of the body and fluidically connected to the plurality of openings, and selective obstruction of at least some of the openings in the plurality of openings while selective introduction of cooling water into at least some other openings in the plurality of openings causes the cooling water to flow through one of a plurality of different cooling water flow paths.

8. A formulation for forming an extrudate with a texture similar to a farm-raised animal counterpart, the formulation including:
cultivated animal cells in an amount between 3%-95 wt % of the formulation;
a dry mix in an amount between 25-65 wt % of the formulation, wherein the dry mix includes a proteinaceous ingredient, a binding ingredient, an emulsifier, and one or more flavorants.

9. The formulation of paragraph 8, wherein the cultivated animal cells have a viscosity between 450-550 cP at 5° C.

10. The formulation of paragraph 8, wherein the binding ingredient is a modified food starch in an amount between 0.078-0.98 wt % of the formulation.

11. The formulation of paragraph 10, wherein the emulsifier is soy lecithin in an amount between 0.25-0.45 wt % of the formulation.

12. The formulation of paragraph 11, wherein the proteinaceous ingredient is a plant-based protein in an amount between 23-43 wt % of the formulation, and wherein the plant-based proteins include at least one of soy protein and wheat protein isolate.

13. The formulation of paragraph 12, wherein the plant-based proteins include: soy protein in an amount between 14-22 wt % of the formulation; and wheat protein isolate in an amount between 10-16 wt % of the formulation.

14. The formulation of paragraph 13, wherein the flavorants includes at least one of dehydrated onion, dehydrated garlic, and salt, and wherein the flavorants are included in an amount between 0.84-1.04 wt % of the formulation.

15. The formulation of any one of paragraphs 8-14, wherein the formulation has a texture selected from the group consisting of a cohesiveness between 0.1 and <1/cm2, an elasticity between 0.1 and <1/cm2, a chewiness between 100-1500 g/cm2, an anisotropic index between 0.5-3, a firmness between 100-1500 g/cm2, or combinations thereof.

16. An extrudate formed from a mixture of cultivated animal cells and a plant-based proteins, wherein the extrudate includes:
an elongated body with a generally elliptical, elliptical-like, or tear-drop shaped cross-section, wherein the elongated body includes irregular folds at a surface of the elongated body and disposed throughout a volume of the elongated body; and
a texture that is similar to a farm-raised animal counterpart.

17. The extrudate of paragraph 16, wherein the farm-raised animal counterpart is selected from the group consisting of poultry, beef, pork, and fish.

18. The extrudate of paragraph 16 or 17, wherein the texture is selected from the group consisting of a cohesiveness between 0.1 and <1/cm2, an elasticity between 0.1 and <1/cm2, a chewiness between 100-1500 g/cm2, an anisotropic index between 0.5-3, a firmness between 100-1500 g/cm2, or combinations thereof.

19. The extrudate of paragraph 18, wherein:
the extrudate is formed from a formulation that includes the mixture of the cultivated animal cells and the plant-based proteins;
the cultivated animal cells are in an amount between 3%-95 wt % of the formulation;
the plant-based proteins are included in a dry mix in an amount between 25-65 wt % of the formulation; and
the dry mix includes the plant-based proteins, a binding ingredient, an emulsifier, and one or more flavorants.

20. The extrudate of paragraph 19, wherein the binding ingredient is a modified food starch in an amount between 0.078-0.98 wt % of the formulation.

21. The extrudate of paragraph 20, wherein the emulsifier is soy lecithin in an amount between 0.25-0.45 wt % of the formulation.

22. The extrudate of paragraph 21, wherein the plant-based proteins are in an amount between 23-43 wt % of the formulation, and wherein the plant-based proteins include at least one of soy protein concentrate, soy protein isolate, and wheat protein isolate.

23. The extrudate of paragraph 22, wherein the plant-based proteins include: soy protein in an amount between 14-22 wt % of the formulation; and wheat protein isolate in an amount between 10-16 wt % of the formulation.

24. The extrudate of paragraph 23, wherein the flavorants includes at least one of dehydrated onion, dehydrated garlic, and salt, and wherein the flavorants are included in an amount between 0.84-1.04 wt % of the formulation.

25. A method for forming an extrudate from a formulation including cultivated animal cells and plant-based proteins, the method including:
receiving an intermediate extrudate into a flow path of a cooling die, wherein:
   the flow path extends from an inlet with a first cross-sectional area at an upstream end of the cooling die to an outlet with a second cross-sectional area at a downstream end of the cooling die, the second cross-sectional area is larger than the first cross-sectional area, the flow path includes a transition region at the upstream end and a forming region at the downstream end,
   the intermediate extrudate is received at the inlet at a first mass flux and crosses an interface between the transition region and the forming region at a second mass flux, wherein the first mass flux is at least 4× greater than the second mass flux;
cooling the intermediate extrudate at a cooling rate, wherein the cooling rate provides a first temperature reduction per unit length of at least 4° C./cm; and
expelling the intermediate extrudate from the cooling die to form the extrudate.

26. The method of paragraph 25, wherein the first mass flux is at least 8× greater than the second mass flux.

27. The method of paragraph 25, wherein the first mass flux is at least 4 kg/cm2 and the second mass flux is less than 2 kg/cm2, preferably the first mass flux is between 6-10 kg/cm2.

28. The method of any one of paragraphs 25-27, wherein the first temperature reduction per unit length of at least 4° C./cm is at a surface of the intermediate extrudate at the interface between the transition region and the forming region.

29. The method of paragraph 25, wherein the cooling rate provides a second temperature reduction per unit length of at least 1° C./cm in a core of the intermediate extrudate.

30. The method of paragraph 25, wherein the cooling rate of the intermediate extrudate peaks in the forming region of the flow path.

31. The method of paragraph 25, wherein the flow path is dimensioned to cause the intermediate extrudate to assume a generally serpentine path through the flow path, and wherein the generally serpentine path imparts irregular folds throughout the intermediate extrudate.

32. The method of paragraph 25, wherein the intermediate extrudate is formed from a dough including cultivated animal cells and plant-based proteins.

33. The method of paragraph 25, wherein:
the flow path includes a transitional region at the upstream end of the body with a length L and a minimum cross-sectional expansion ratio of at least 2× for any continuous length L/2 over the length L of the transitional region; and
the flow path includes a forming region extending from the transitional region to the outlet.

34. A system for forming an extrudate, the system including:
an extruder barrel housing a set of screws;
a set of feed streams coupled to one or more inlets of the extruder barrel, wherein the set of feed streams provide feed material processed within the extruder barrel;
a cooling die fluidically coupled to an outlet of the extruder barrel, the cooling die further including a body defining a flow path extending from an inlet at an upstream end of the body to an outlet at a downstream end of the body, wherein:
   the inlet has a first cross-sectional area,
   the outlet has a second cross-sectional area that is larger than the first cross-sectional area, the flow path includes a transitional region at the upstream end of the body with a length L and a minimum cross-sectional expansion ratio of at least 2× for any continuous length L/2 over the length L of the transitional region, and the flow path includes a forming region extending from the transitional region to the outlet.

35. The system of paragraph 34, wherein the extruder barrel is configured with a temperature profile having at least five different temperature zones.

36. The system of paragraph 34, wherein the transitional region has a first cross-sectional expansion ratio of 8× calculated from the inlet to a distance L/2 from the inlet.

37. The system of paragraph 34, wherein the transitional region has a second cross-sectional expansion ratio of 12× calculated from the inlet to the outlet.

38. The system according to paragraph 34, further including:
a cooling system coupled with the body, wherein the cooling system is configured to cool an intermediate extrudate flowing through the flow path, and wherein the cooling system is configured to provide a selected cooling rate.

39. The system of paragraph 38, wherein the cooling system is configured to provide a first cooling rate of at least 4° C./cm to an exterior of the intermediate extrudate at an end of the transition region.

40. The system of paragraph 39, wherein the cooling system is configured to provide a second cooling rate of at least 1° C./cm to an interior of the intermediate extrudate at an end of the transition region.

41. The system of paragraph 40, wherein the cooling system is configured provide the first cooling rate and the second cooling rate to the intermediate extrudate based on a mass flux through the transitional region, wherein the mass flux is less than 12 kg/cm2 at the inlet and less than 2 kg/cm2 at an end of the transitional region.

42. The system of paragraph 4, wherein the mass flux at the inlet is at least 4 times higher than the mass flux at the end of the transition region, preferably at least 8 times higher than the mass flux at the end of the transition region, preferably at least 12 times higher than the mass flux at the end of the transition region.

43. The system of paragraph 34, wherein:
the body includes a plurality of openings disposed in one or more sidewalls of the body;
the body defines a set of channels extending throughout a width of the body and fluidically connected to the plurality of openings, and
selective obstruction of at least some of the openings in the plurality of openings while selective introduction of cooling water into at least some other openings in the plurality of openings causes the cooling water to flow through one of a plurality of different cooling water flow paths.

44. An apparatus for forming an extrudate, the apparatus including:
a body defining a flow path extending from an inlet at an upstream end of the body to an outlet at a downstream end of the body, wherein:
   the inlet has a first cross-sectional area with a first geometric shape,
   the outlet has a second cross-sectional area with a second geometric shape, and the second cross-sectional area is larger than the first cross-sectional area and the second geometric shape is an ellipse, ellipse-like, or tear-drop.

45. The apparatus of paragraph 44, wherein the first geometric shape is a circle.

46. The apparatus of paragraph 44 or 45, wherein the flow path includes a transitional region with a circular cross-section at a first end and an elliptical, elliptical-like, or tear-drop shaped cross-section at a second end.

47. The apparatus of paragraph 46, wherein the flow path includes a forming region between the second end of the transitional region and the outlet of the flow path.

48. The apparatus of paragraph 47, wherein the elliptical, elliptical-like, or tear-drop shaped cross-section at the second end and the second geometric shape of the outlet have the same dimensions.

49. The apparatus of paragraph 44, wherein the ellipse, ellipse-like, or tear drop has a major diameter and a minor diameter, and wherein the major diameter is at least 2× larger than the minor diameter, preferably about 3× larger than the minor diameter.

50. The apparatus of paragraph 44, wherein the second cross-sectional area is at least 10× greater than the first cross-sectional area.

While various embodiments have been particularly shown and described with reference to the drawings, it will be understood by those skilled in the art that various changes in form and detail may be made therein without departing from the spirit and scope of the disclosure. The inventors expect skilled artisans to employ such variations as appropriate, and the inventors intend embodiments of the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

### Examples

### Equipment Specifications

The various exemplary extrudates described in the present disclosure was formed with equipment having the specifications identified in Table 1. The equipment specifications are non-limiting and can be used in-part or in-whole as embodiments of the disclosure.

TABLE 1
Equipment Specifications.
Equipment

| Extruder | Extruder | | TwinLab-F 20/40 Extruder with M390 Alloy |
|---|---|---|---|
| System | | | barrel liner (Brabender) |
| Barrel | Barrel Water Cooling | | WTD 2es Temperature control units (Weinreich) |
| Cooling | Unit | | |
| System | | | |
| Dry | Dry Feeder | | DDW-MD-DDSR20-4 Dry Feeder (Brabender |
| Feeding | | | Technologie) |
| System | | | |
| Liquid | Pump | | 323S (Watson Marlow) |
| Feeding | | | |
| System | | | |
| Cooling | Cooling | Cooling Die | 4-module cooling die (Brabender), can be elliptical |
| Die System | Die | Elements | (e.g., regular ellipse), elliptical-like (e.g., irregular |
| | | | ellipse), tear-drop, round, rectangular, etc. |

| | | |
|---|---|---|
| Cooling Die | Cooling Die Entire Dimensions (Module | See |
| Dimensions | A) | below; |
| | | Section |
| | | A-A |
| | Cooling Die Cavity Inlet, Round | 12.7 |
| | Diameter (Module A) [mm] | |
| | Cooling Die Cavity Outlet, Elliptical | 75.0 |
| | Length (Module A) [mm] | |
| | Cooling Die Cavity Outlet, Elliptical | 26.0 |
| | Height (Module A) [mm] | |
| | Cooling Die Cavity Length (Module A) | See |
| | | below; |
| | | Section |
| | | A-A |
| | Cooling Die Cavity Angle (Module A) | 20.8° |
| | Cooling Die Entire Dimensions (Module | See |
| | B, C, D) | below; |
| | | Section |
| | | B-B |
| | Cooling Die Cavity Inlet/Outlet, | 75.0 |
| | Elliptical Length (Module B, C, D) [mm] | |
| | Cooling Die Cavity Inlet/Outlet, | 26.0 |
| | Elliptical Height (Module B, C, D) [mm] | |
| Theoretical | Volume of Module A Cavity [cm3] | 95.443 |
| Cavity | Volume of each Module B/C/D Cavity | 183.69 |
| Volume | [cm3] | |
| | Volume of All Modules Cavity [cm3] | 664.37 |

| | | |
|---|---|---|
| Cooling | Chiller | FC600 Chiller (Julabo) |
| Unit | Cooling | See FIGS. 4 and 5 |
| | Tubing | |
| | Connection | |

Exemplary formulations are included in the tables below. In certain formulations shown below, other proteinaceous ingredients may be included by a corresponding decrease in the amount of listed proteins to achieve a comparable product.

TABLE 2
Dry Mix and Water Formula 1.

| Ingredient | Amount (wt %) | Possible Range (wt %) |
|---|---|---|
| Water | 60.00 | 25-95 |
| Soy Protein | 21.24 | 0-75 |
| Wheat Protein | 16.30 | 0-75 |
| Other Proteinaceous | 0 | 0-75 |
| Ingredient | | |
| Food Starch-Modified | 1 | 0-10 |
| Lecithin | 0.4 | 0-5 |
| Spices | 0.58 | 0-10 |
| Salt | 0.48 | 0-5 |

TABLE 3
Dry Mix and Water Formula 2.

| Ingredient | Amount (wt %) | Possible Range (wt %) |
|---|---|---|
| Water | 58.48 | 25-95 |
| Soy Protein | 22.8 | 0-75 |
| Wheat Protein | 17.2 | 0-75 |
| Lecithin | 0.42 | 0-5 |
| Canola Oil | 1 | 0-20 |
| Methyl Cellulose | 0.1 | 0-5 |

TABLE 4
Dry Mix and Water Formula 3.

| Ingredient | Amount (wt %) | Possible Range (wt %) |
|---|---|---|
| Water | 60 | 25-95 |
| Soy Protein | 22 | 0-75 |
| Wheat Protein | 14.16 | 0-75 |
| Potato Protein | 2 | 0-75 |
| Salt | 0.64 | 0-5 |
| Lecithin | 0.4 | 0-5 |
| Tapioca Solids | 0.8 | 0-5 |

TABLE 5
Dry Mix and Water Formula 4.

| Ingredient | Amount (wt %) | Possible Range (wt %) |
|---|---|---|
| Water | 60 | 25-95 |
| Soy Protein | 31.28 | 0-75 |
| Wheat Protein | 8 | 0-75 |
| Salt | 10.72 | 0-5 |

TABLE 6
Dry Mix and Water Formula 5.

| Ingredient | Amount (wt %) | Possible Range (wt %) |
|---|---|---|
| Water | 60 | 25-95 |
| Soy Protein | 21.88 | 0-75 |
| Wheat Protein | 14.08 | 0-75 |
| Lecithin | 0.4 | 0-5 |
| Palm Oil | 1 | 0-20 |

TABLE 7
Cell Paste Formulation.

| Ingredient | Amount (wt %) | Possible Range (wt %) |
|---|---|---|
| Cultivated Animal Cells | 100 | |

TABLE 8
Dry Mix and Cell Paste Formula 1

| Ingredient | Amount (wt %) | Possible Range (wt %) |
|---|---|---|
| Cultivated Animal Cells | 65.00 | 0-95 |
| Soy Protein | 19.74 | 0-75 |
| Pea Protein | 0 | 0-75 |
| Wheat Protein | 13.11 | 0-75 |
| Food Starch-Modified | 0.88 | 0-10 |
| Lecithin | 0.35 | 0-5 |
| Spices | 0.50 | 0-10 |
| Salt | 0.42 | 0-5 |

TABLE 9
Dry Mix and Cell Paste Formula 2

| Ingredient | Amount (wt %) | Possible Range (wt %) |
|---|---|---|
| Cultivated Animal Cells | 65.00 | 0-95 |
| Soy Protein | 21.89 | 0-75 |
| Wheat Protein | 11.88 | 0-75 |
| Food Starch-Modified | 0.88 | 0-10 |
| Lecithin | 0.35 | 0-5 |

TABLE 10
Dry Mix and Cell Paste Formula 3

| Ingredient | Amount (wt %) | Possible Range (wt %) |
|---|---|---|
| Cultivated Animal Cells | 65.00 | 0-95 |
| Soy Protein | 19.88 | 0-75 |
| Wheat Protein | 14.56 | 0-75 |
| Salt | 0.56 | 0-5 |

TABLE 11
Optional Ingredients

| Optional Ingredient | Amount (wt %) |
|---|---|
| Water | 0-80 |
| Proteinaceous Ingredient* | 0-50 |
| Starch (Any type of starch) | 0-5 |
| Gum (Any type of gum) | 0-5 |
| Oil/Fat (Any type of oil or fat) | 0-10 |
| Emulsifier (Any type of emulsifier) | 0-5 |
| Spice (Any type of spice) | 0-1 |
| Flavor (any type of flavor) | 0-5 |
| Yeast Extract/Yeast (any type of | 0-5 |
| yeast or yeast extract) | |
| Salt (any type of salt) | 0-5 |
| Sugar/Syrup (any type of salt or | 0-5 |
| syrup) | |
| Gelling agent (Any type of gelling | 0-10 |
| agent) | |
| Fiber (Any type of fiber) | 0-5 |
| Enzyme (any type of enzyme) | 0-5 |
| Acid (any type of acid) | 0-5 |
| Preservative (any type of | 0-5 |
| preservative) | |
| Antimicrobial (any type of | 0-5 |
| antimicrobial) | |
| Antioxidant (any type of antioxidant) | 0-5 |
| Vitamin (any type of vitamin) | 0-1 |
| Mineral (any type of mineral | 0-5 |
| Color (any type of color) | 0-1 |
| Fruit/Vegetable Juice (any type of | 0-5 |
| juice) | |

*These proteinaceous ingredients can include pulse/legume, grain, seed, nut, starch, insect, flours (e.g., pea flour, soy flour, wheat flour, etc.), fungi, animal or animal cell, plant cell, or microorganism. The proteinaceous ingredients can be obtained by any process, including extraction, filtration, microbial fermentation, biomass fermentation, or cellular culture, to name a few.

### Process Parameters

The exemplary extrudate described in the disclosure which was formed with a throughput of 10 kg/hr was formed according to the process parameters included in the table below.

TABLE 12
Process Parameters

| | | | | OV | |
|---|---|---|---|---|---|
| | | | SP (Set | (Observed | |
| Process | | | Point) | Value) | Range |
| Extruder | Barrel Temp | Z1 [° C.] | 50 | 40-60 | <100 |
| | Setting | Z2 [° C.] | 105 | 80-120 | 25-180 |
| | | Z3 [° C.] | 130 | 100-150 | 25-180 |
| | | Z4 [° C.] | 130 | 100-150 | 25-180 |
| | | Z5 [° C.] | 80 | 60-120 | 25-180 |
| | Barrel Water | Barrel Water Cooling | 20 | <60 | 0-80 |
| | Cooling Unit | Unit Temp [° C.] | | | |
| | Screw | Screw Speed [RPM] | 900 | 800-1000 | 200-1500 |
| Dry | Dry Feed Rate Setting [kg/hr] | | 3.5 | 3-4 | 1.5-175 |
| Feeder | | | | | |
| Liquid | Liquid Feed Rate Setting [kg/hr] | | 6.5 | 6-7 | 2.5-350 |
| Feeder | | | | | |
| Dry (Solids) to Liquid (Water/Moisture + Oil/Fat) | | | 0.54 (35:65) | | 1:9-9:1 |
| Ratio | | | | | |
| Water to Oil Ratio | | | (100:0) | | 1:0-3:1 |
| Through | Theoretical Throughput [kg/hr] | | 10 | | 2.5-750 |
| put | | | | | |
| Die | Die Pressure (psi) | | | 70-110 | 50-300 |
| | Die Temperature [° C.] | | | 110-140 | 25-180 |
| Cooling Die | Cooling | Cooling Die Water | 30 | | 0-90 |
| | System | Temp [° C.] | | | |
| | Cooling Die | Surface Temperature of | | 35-45 | 1-120 |
| | Parameters | Cooling Die Cavity | | | |
| | | (Module A) [° C.] | | | |
| | | Surface Temperature of | | 35-45 | 1-120 |
| | | Cooling Die Cavity | | | |
| | | (Module B) [° C.] | | | |
| | | Surface Temperature of | | 35-45 | 1-120 |
| | | Cooling Die Cavity | | | |
| | | (Module C) [° C.] | | | |
| | | Surface Temperature of | | 35-45 | 1-1200 |
| | | Cooling Die Cavity | | | |
| | | (Module D) [° C.] | | | |
| | | Cooling Die Pressure | | 0-5 | 0-50 |
| | | (Module A) [psi] | | | |
| | | Cooling Die Pressure | | 0-5 | 0-50 |
| | | (Module B) [psi] | | | |
| | | Cooling Die Pressure | | 0-5 | 0-50 |
| | | (Module C) [psi] | | | |
| | | Cooling Die Pressure | | 0-5 | 0-50 |
| | | (Module D) [psi] | | | |

### Extrudate Characteristics

An extrudate can be formed by processing a formulation (as indicated in one of the Formulation tables) with an extruder system including extruder 100 and cooling die 300 operating at exemplary process parameters (indicated in one of the Process Parameter Tables). The extrudate possesses organoleptic properties like or similar to a farm-raised animal counterpart, particularly after the extrudate has been cooked to form an imitation meat product. Exemplary characteristics are included in following table.

TABLE 13
Extrudate Characteristics

| Analytical parameter | | Value | Range |
|---|---|---|---|
| Proximate | Moisture Content [%] | 60.0 | 25-95 |
| Analysis | Protein, dry weight [%] | 83.4 | 10-100 |
| | Fat, dry weight [%] | 5.0 | 0-20 |
| Texture | Firmness/Hardness per | 459 ± 148 (at 5 kg/hr throughput) | 100-1500 |
| | Contact Surface Area [g/cm2] | 616 ± 101 (at 10 kg/hr throughput) | |
| | | 824 ± 184 (at 15 kg/hr throughput) | |
| | Cohesiveness per Contact | 0.37 ± 0.12 (at 5 kg/hr throughput) | 0.1 to <1 |
| | Surface Area [/cm2] | 0.39 ± 0.06 (at 10 kg/hr throughput) | |
| | | 0.39 ± 0.07 (at 15 kg/hr throughput) | |
| | Elasticity/Springiness per | 0.49 ± 0.04 (at 5 kg/hr throughput) | 0.1 to <1 |
| | Contact Surface Area[/cm2] | 0.52 ± 0.01 (at 10 kg/hr throughput) | |
| | | 0.52 ± 0.01 (at 15 kg/hr throughput) | |
| | Chewiness per Contact | 418 ± 154 (at 5 kg/hr throughput) | 100-1500 |
| | Surface Area [g/cm2] | 1033 ± 181 (at 10 kg/hr throughput) | |
| | | 830 ± 167 (at 15 kg/hr throughput) | |
| | Anisotropic Index (Ratio of | 0.87 (at 5 kg/hr throughput) | 0.5-3 |
| | lengthwise strength; | 1.48 (at 10 kg/hr throughput) | |
| | longitudinal force to crosswise | 1.75 (at 15 kg/hr throughput) | |
| | strength; transversal force) | | |
| Sensory | Appearance Acceptability (1- | 4 (at 5 kg/hr throughput) | |
| | 5 scale) | 3 (at 10 kg/hr throughput) | |
| | | 2 (at 15 kg/hr throughput) | |
| | Aroma Acceptability (1-5 | 4 (at 5 kg/hr throughput) | |
| | scale) | 4 (at 10 kg/hr throughput) | |
| | | 4 (at 15 kg/hr throughput) | |
| | Flavor Acceptability (1-5 | 3 (at 5 kg/hr throughput) | |
| | scale) | 3 (at 10 kg/hr throughput) | |
| | | 3 (at 15 kg/hr throughput) | |
| | Texture Acceptability (1-5 | 4 (at 5 kg/hr throughput) | |
| | scale) | | |
| | | 3 (at 10 kg/hr throughput) | |
| | | 2 (at 15 kg/hr throughput) | |
| Color | Top & Bottom of extrudate | L* = 79.75 ± 2.74 | |
| | | a* = 4.25 ± 0.32 | |
| | | b* = 20.64 ± 0.89 | |
| | Cross section of extrudate | L* = 47.59 ± 1.52 | |
| | | a* = 1.06 ± 0.37 | |
| | | b* = 9.46 ± 0.31 | |
| Physicochemical | Density [g/cc] | 1.06 ± 0.05 (at 10 kg/hr throughput) | 0.25-1.5 |
| | pH | 6.5 | 4-10 |
| Temp | Surface Temperature Cooling | 95 (at 10 kg/hr throughput) | 1-120 |
| | Die (Module A) [° C.] | | |
| | Surface Temperature Cooling | 45 (at 10 kg/hr throughput) | 1-120 |
| | Die (Module B) [° C.] | | |
| | Surface Temperature Cooling | 40 (at 10 kg/hr throughput) | 1-120 |
| | Die (Module C) [° C.] | | |
| | Surface Temperature Cooling | 37 (at 10 kg/hr throughput) | 1-120 |
| | Die (Module D) [° C.] | | |
| | Calculated Internal | 120 (at 10 kg/hr throughput) | <160 |
| | Temperature Cooling Die | | |
| | (Module A) [° C.] | | |
| | Calculated Internal | 107 (at 10 kg/hr throughput) | <140 |
| | Temperature Cooling Die | | |
| | (Module B) [° C.] | | |
| | Calculated Internal | 92 (at 10 kg/hr throughput) | <120 |
| | Temperature Cooling Die | | |
| | (Module C) [° C.] | | |
| | Measured Internal | 67 (at 10 kg/hr throughput) | <100 |
| | Temperature Cooling Die | | |
| | (Module D) [° C.] | | |
| Volume | Extrudate Volume (Module A) | 90.1 (at 10 kg/hr throughput) | |
| | [cm3] | | |
| | Extrudate Volume (Module B) | 152 (at 10 kg/hr throughput) | |
| | [cm3] | | |
| | Extrudate Volume (Module C) | 176 (at 10 kg/hr throughput) | |
| | [cm3] | | |
| | Extrudate Volume (Module D) | 182.3 (at 10 kg/hr throughput) | |
| | [cm3] | | |
| | Extrudate Volume (All | 610.4 (at 10 kg/hr throughput) | |
| | Modules; A, B, C, and D) | | |
| | [cm3] | | |

### Cooling Die Void Space Parameter

Various organoleptic properties of an imitation meat product formed from an exemplary formulation processed according to the systems and methods can be attributed to the folds disposed throughout the surface and into the volume of the extrudate. The folds are caused by the serpentine motion of the intermediate extrudate through the flow path 702, which is facilitated (at least in part) by the void space in the flow path 702 between the exterior surface of the intermediate extrudate and the sidewalls of the dies that form the flow path 702. The following table identifies the amount of void space in the flow path 702 as an intermediate extrudate is conveyed through at 10 kg/hr.

TABLE 14
Extrudate Characteristics in Cooling Die

| Volume | | Value |
|---|---|---|
| Cavity | Module A | 96.4 |
| [cm3] | Module B/C/D | 183.8 |
| | All Modules (A, B, C, and D) | 647.7 |
| Cavity | Module A | 85.0 |
| Filled with | Module B | 143.4 |
| Extrudate | Module C | 166.0 |
| (10 kg/hr) | Module D | 172.0 |
| [cm3] | All Modules (A, B, C, and D) | 566.4 |
| Void | Module A | 11.36 |
| Volume | Module B | 40.4 |
| (Gap | Module C | 17.8 |
| Between | Module D | 11.8 |
| Cavity and | All Modules (A, B, C, and D) | 81.3 (12.6% |
| Extrudate) | | of Cavity |

### Analysis of Extrudate Characteristics

The extrudate characteristics were determined using the following analytical methods and/or equipment.

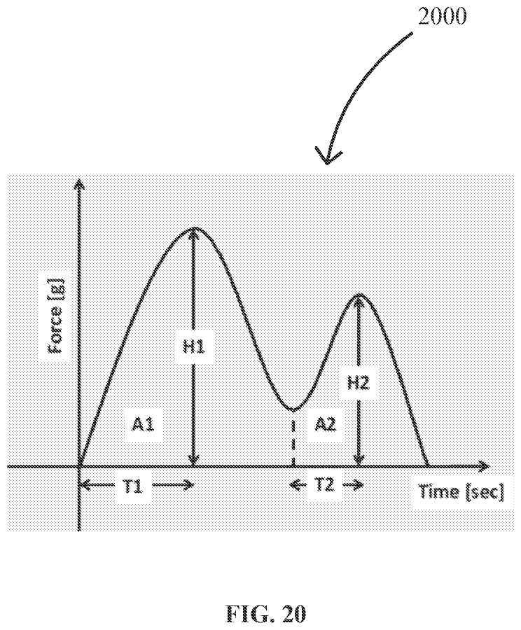

TABLE 15
Analysis of Extrudate Characteristics

| Analytical parameter | | Analysis Method |
|---|---|---|
| Proximate | Moisture Content | Analyzed with moisture analyzer |
| | | (Computrac MAX 4000XL, Arizona |
| | | Instrument) using the following setting: |
| | | TEST TEMP: 170° C. |
| | | HISTART TEMP: 190° C. IDLE TEMP: |
| | | 50° C. START TEMP CTRL: On |
| | | END ON: Prediction 95% SAMPLE SIZE: |
| | | 2.0 g ± 0.5 g |
| | Protein | Calculated from the value (nutritional spec) |
| | Fat | of each ingredients used |
| Texture | Firmness/Hardness per Contact | Analyzed with texture analyzer (TA.XT |
| | Surface Area (The peak force | Plus, Texture Technologies). A piece of |
| | that occurs during the first | extrudate was cut into 15 mm cubes with a |
| | compression, per the surface area | sharp knife to minimize potential variation |
| | of sample in contact with texture | by sample size. 12 samples were |
| | analyzer probe) | compressed with a T25/1000 probe (50.8 |
| | Cohesiveness (How well a | mm diameter cylinder) at 1 mm/sec with |
| | sample withstands a second | 50% strain, which is 7.5 mm distant from |
| | deformation relative to its | the sample height. The probe was returned |
| | resistance under the first | to 20 mm height at 5 mm/sec, and the |
| | deformation, per the surface area | samples were compressed with the same |
| | of sample | condition. Firmness/Hardness (H1), |
| | in contact with texture | Cohesiveness (A2/A1) where A1 and A2 |
| | analyzer probe) | represent areas under the curve, |
| | Elasticity/Springiness (How well | Elasticity/Springiness (T2/T1), Chewiness |
| | a sample physically springs back | (H1 × A2/A1 × T2/T1) were calculated as |
| | after it has been deformed during | shown in graph 2000 in FIG. 20 and |
| | the first compression, per the | divided by the contact surface area of the |
| | surface area of sample in contact | cubic sample. |
| | with texture analyzer probe) | |
| | Chewiness (The energy required | |
| | for a sample to get disintegrated | |
| | during two-time compression, | |
| | per the surface area of sample in | |
| | contact with texture analyzer | |
| | probe) | |
| | Anisotropic Index (Ratio of | Analyzed with texture analyzer (TA.XT |
| | lengthwise strength; longitudinal | Plus, Texture Technologies). A piece of |
| | force and crosswise strength; | extrudate was cut into 15 mm cubes with a |
| | transversal force) | sharp knife to minimize potential variation |
| | | by sample size. 12 samples were |
| | | compressed/cut in longitudinal direction |
| | | (parallel to extrusion flow) with a T7 probe |
| | | (60 mm wide knife edge) at 1 mm/sec with |
| | | 75% strain, which is 10 mm distant from |
| | | the sample height. Another 12 samples were |
| | | tested in transversal direction |
| | | (perpendicular to extrusion flow). The ratio |
| | | of lengthwise strength to crosswise strength |
| | | (longitudinal force to transversal force) was |
| | | calculated as anisotropic index. |
| Sensory | | Pan-seared at 200-220° C. for 2 |
| | | minutes/side, served to three panelists; |
| | | appearance, aroma, flavor, and texture |
| | | acceptability scores were rated in 1-5 scale |
| | | (1: Highly unacceptable, 2: Moderately |
| | | unacceptable, 3: Marginally acceptable, 4: |
| | | Moderately acceptable, 5: Highly |
| | | acceptable) |
| Color | | Analyzed with chromameter (CR-400 |
| | | Chroma Meter, Konica Minolta) |
| Physicochemical | Density | Calculated by dividing sample weight by |
| | | incremental volume measured when |
| | | submerged in canola oil |
| | pH | Measured at 25° C. with pH meter |
| | | (SevenExcellence, Mettler Toledo) and an |
| | | electrode (InLab Solids Go-ISM electrode, |
| | | Mettler Toledo) |
| | Moisture Content | Same as above |

| Temperature | Measured with thermocouple probe and |
|---|---|
| | data logger (HH309A, Omega) |
| Volume | Measured by submerging sample in water |

1. An apparatus for forming an extrudate, the apparatus comprising:
a body defining a flow path extending from an inlet at an upstream end of the body to an outlet at a downstream end of the body, wherein:
the inlet has a first cross-sectional area,
the outlet has a second cross-sectional area that is larger than the first cross-sectional area,
the flow path includes a transitional region at the upstream end of the body with a length L and a minimum cross-sectional expansion ratio of at least 2× for any continuous length L/2 over the length L of the transitional region, and
the flow path includes a forming region extending from the transitional region to the outlet.

2. The apparatus of claim 1, wherein the transitional region has a first cross-sectional expansion ratio of 8× calculated from the inlet to a distance L/2 from the inlet.

3. The apparatus of claim 2, wherein the transitional region has a second cross-sectional expansion ratio of 12× calculated from the inlet to the outlet.

4. The apparatus of claim 51, wherein the cooling system is configured to provide a first cooling rate of at least 4° C./cm to an exterior of the intermediate extrudate at an end of the transition region.

5. The apparatus of claim 4, wherein the cooling system is configured to provide a second cooling rate of at least 1° C./cm to an interior of the intermediate extrudate at an end of the transition region.

6. The apparatus of claim 5, wherein the cooling system is configured to provide the first cooling rate and the second cooling rate to the intermediate extrudate based on a mass flux through the transitional region, wherein the mass flux is less than 12 kg/cm2 at the inlet and less than 2 kg/cm2 at an end of the transitional region, preferably, wherein the mass flux at the inlet is about 4× higher than the mass flux at the end of the transition region or is about 8× higher than the mass flux at the end of the transition region.

7. The apparatus of claim 1, wherein the body includes a plurality of openings disposed in one or more sidewalls of the body; the body defines a set of channels extending throughout a width of the body and fluidically connected to the plurality of openings, and selective obstruction of at least some of the openings in the plurality of openings while selective introduction of cooling water into at least some other openings in the plurality of openings causes the cooling water to flow through one of a plurality of different cooling water flow paths.

8. A formulation for forming an extrudate with a texture similar to a farm-raised animal counterpart, the formulation comprising:
cultivated animal cells in an amount between 3%-95 wt % of the formulation; and
a dry mix in an amount between 25-65 wt % of the formulation, wherein the dry mix includes a proteinaceous ingredient, a binding ingredient, an emulsifier, and one or more flavorants.

9. The formulation of claim 8, wherein the cultivated animal cells have a viscosity between 450-550 cP at 5° C.

10. The formulation of claim 8, wherein the binding ingredient is a modified food starch in an amount between 0.078-0.98 wt % of the formulation.

11. The formulation of claim 10, wherein the emulsifier is soy lecithin in an amount between 0.25-0.45 wt % of the formulation.

12. The formulation of claim 11, wherein the proteinaceous ingredient is a plant-based protein in an amount between 23-43 wt % of the formulation, and wherein the plant-based proteins comprise at least one of soy protein and wheat protein isolate.

13. The formulation of claim 12, wherein the plant-based proteins comprise:
soy protein in an amount between 14-22 wt % of the formulation; and
wheat protein isolate in an amount between 10-16 wt % of the formulation.

14. The formulation of claim 13, wherein the flavorants includes at least one of dehydrated onion, dehydrated garlic, and salt, and wherein the flavorants are included in an amount between 0.84-1.04 wt % of the formulation.

15. The formulation of any one of claims 8-14, wherein the formulation has a texture selected from the group consisting of a cohesiveness between 0.1 and <1/cm2, an elasticity between 0.1 and <1/cm2, a chewiness between 100-1500 g/cm2, an anisotropic index between 0.5-3, a firmness between 100-1500 g/cm2, or combinations thereof.

16. An extrudate formed from a mixture of cultivated animal cells and a plant-based proteins, wherein the extrudate comprises:
an elongated body with a generally elliptical, elliptical-like, or tear-drop shaped cross-section, wherein the elongated body includes irregular folds at a surface of the elongated body and disposed throughout a volume of the elongated body; and
a texture that is similar to a farm-raised animal counterpart.

17. The extrudate of claim 16, wherein the farm-raised animal counterpart is selected from the group consisting of poultry, beef, pork, and fish.

18. The extrudate of claim 16 or 17, wherein the texture is selected from the group consisting of a cohesiveness between 0.1 and <1/cm2, an elasticity between 0.1 and <1/cm2, a chewiness between 100-1500 g/cm2, an anisotropic index between 0.5-3, a firmness between 100-1500 g/cm2, or combinations thereof.

19. The extrudate of claim 18, wherein:
the extrudate is formed from a formulation that includes the mixture of the cultivated animal cells and the plant-based proteins;
the cultivated animal cells are in an amount between 3%-95 wt % of the formulation;
the plant-based proteins are included in a dry mix in an amount between 25-65 wt % of the formulation; and
the dry mix includes the plant-based proteins, a binding ingredient, an emulsifier, and one or more flavorants.

20. The extrudate of claim 19, wherein the binding ingredient is a modified food starch in an amount between 0.078-0.98 wt % of the formulation.

21. The extrudate of claim 20, wherein the emulsifier is soy lecithin in an amount between 0.25-0.45 wt % of the formulation.

22. The extrudate of claim 21, wherein the plant-based proteins are in an amount between 23-43 wt % of the formulation, and wherein the plant-based proteins comprise at least one of soy protein concentrate, soy protein isolate, and wheat protein isolate.

23. The extrudate of claim 22, wherein the plant-based proteins comprise: soy protein in an amount between 14-22 wt % of the formulation; and wheat protein isolate in an amount between 10-16 wt % of the formulation.

24. The extrudate of claim 23, wherein the flavorants includes at least one of dehydrated onion, dehydrated garlic, and salt, and wherein the flavorants are included in an amount between 0.84-1.04 wt % of the formulation.

25. A method for forming an extrudate from a formulation including cultivated animal cells and plant-based proteins, the method comprising:
receiving an intermediate extrudate into a flow path of a cooling die, wherein:
the flow path extends from an inlet with a first cross-sectional area at an upstream end of the cooling die to an outlet with a second cross-sectional area at a downstream end of the cooling die, the second cross-sectional area is larger than the first cross-sectional area, the flow path includes a transition region at the upstream end and a forming region at the downstream end, and
the intermediate extrudate is received at the inlet at a first mass flux and crosses an interface between the transition region and the forming region at a second mass flux, wherein the first mass flux is at least 4× greater than the second mass flux;
cooling the intermediate extrudate at a cooling rate, wherein the cooling rate provides a first temperature reduction per unit length of at least 4° C./cm; and
expelling the intermediate extrudate from the cooling die to form the extrudate.

26. The method of claim 25, wherein the first mass flux is at least 8× greater than the second mass flux.

27. The method of claim 25, wherein the first mass flux is at least 4 kg/cm2 and the second mass flux is less than 2 kg/cm2, preferably the first mass flux is between 6-10 kg/cm2.

28. The method of any one of claims 25-27, wherein the first temperature reduction per unit length of at least 4° C./cm is at a surface of the intermediate extrudate at the interface between the transition region and the forming region.

29. The method of claim 25, wherein the cooling rate provides a second temperature reduction per unit length of at least 1° C./cm in a core of the intermediate extrudate.

30. The method of claim 25, wherein the cooling rate of the intermediate extrudate peaks in the forming region of the flow path.

31. The method of claim 25, wherein the flow path is dimensioned to cause the intermediate extrudate to assume a generally serpentine path through the flow path, and wherein the generally serpentine path imparts irregular folds throughout the intermediate extrudate.

32. The method of claim 25, wherein the intermediate extrudate is formed from a dough comprising cultivated animal cells and plant-based proteins.

33. The method of claim 25, wherein:
the flow path includes a transitional region at the upstream end of the body with a length L and a minimum cross-sectional expansion ratio of at least 2× for any continuous length L/2 over the length L of the transitional region; and
the flow path includes a forming region extending from the transitional region to the outlet.

34. A system for forming an extrudate, the system comprising:
an extruder barrel housing a set of screws;
a set of feed streams coupled to one or more inlets of the extruder barrel, wherein the set of feed streams provide feed material processed within the extruder barrel; and
a cooling die fluidically coupled to an outlet of the extruder barrel, the cooling die further comprising a body defining a flow path extending from an inlet at an upstream end of the body to an outlet at a downstream end of the body, wherein:
the inlet has a first cross-sectional area,
the outlet has a second cross-sectional area that is larger than the first cross-sectional area, the flow path includes a transitional region at the upstream end of the body with a length L and a minimum cross-sectional expansion ratio of at least 2× for any continuous length L/2 over the length L of the transitional region, and the flow path includes a forming region extending from the transitional region to the outlet.

35. The system of claim 34, wherein the extruder barrel is configured with a temperature profile having at least five different temperature zones.

36. The system of claim 34, wherein the transitional region has a first cross-sectional expansion ratio of 8× calculated from the inlet to a distance L/2 from the inlet.

37. The system of claim 34, wherein the transitional region has a second cross-sectional expansion ratio of 12× calculated from the inlet to the outlet.

38. The system according to claim 34, further comprising:
a cooling system coupled with the body, wherein the cooling system is configured to cool an intermediate extrudate flowing through the flow path, and wherein the cooling system is configured to provide a selected cooling rate.

39. The system of claim 38, wherein the cooling system is configured to provide a first cooling rate of at least 4° C./cm to an exterior of the intermediate extrudate at an end of the transition region.

40. The system of claim 39, wherein the cooling system is configured to provide a second cooling rate of at least 1° C./cm to an interior of the intermediate extrudate at an end of the transition region.

41. The system of claim 40, wherein the cooling system is configured provide the first cooling rate and the second cooling rate to the intermediate extrudate based on a mass flux through the transitional region, wherein the mass flux is less than 12 kg/cm2 at the inlet and less than 2 kg/cm2 at an end of the transitional region.

42. The system of claim 4, wherein the mass flux at the inlet is at least 4 times higher than the mass flux at the end of the transition region, preferably at least 8 times higher than the mass flux at the end of the transition region, preferably at least 12 times higher than the mass flux at the end of the transition region.

43. The system of claim 34, wherein:
the body includes a plurality of openings disposed in one or more sidewalls of the body;
the body defines a set of channels extending throughout a width of the body and fluidically connected to the plurality of openings, and
selective obstruction of at least some of the openings in the plurality of openings while selective introduction of cooling water into at least some other openings in the plurality of openings causes the cooling water to flow through one of a plurality of different cooling water flow paths.

44. An apparatus for forming an extrudate, the apparatus comprising:
a body defining a flow path extending from an inlet at an upstream end of the body to an outlet at a downstream end of the body, wherein:
the inlet has a first cross-sectional area with a first geometric shape,
the outlet has a second cross-sectional area with a second geometric shape, and
the second cross-sectional area is larger than the first cross-sectional area and the second geometric shape is an ellipse, ellipse-like, or tear-drop.

45. The apparatus of claim 44, wherein the first geometric shape is a circle.

46. The apparatus of claim 44, wherein the flow path includes a transitional region with a circular cross-section at a first end and an elliptical, elliptical-like, or tear-drop shaped cross-section at a second end.

47. The apparatus of claim 46, wherein the flow path includes a forming region between the second end of the transitional region and the outlet of the flow path.

48. The apparatus of claim 47, wherein the elliptical, elliptical-like, or tear-drop shaped cross-section at the second end and the second geometric shape of the outlet have the same dimensions.

49. The apparatus of claim 44, wherein the ellipse, ellipse-like, or tear drop has a major diameter and a minor diameter, and wherein the major diameter is at least 2× larger than the minor diameter, preferably about 3× larger than the minor diameter.

50. The apparatus of claim 44, wherein the second cross-sectional area is at least 10× greater than the first cross-sectional area.

51. The apparatus of claim 1, further comprising a cooling system coupled with the body, wherein the cooling system is configured to cool an intermediate extrudate flowing through the flow path, and wherein the cooling system is configured to provide a selected cooling rate.
